(19) United States
(12) Patent Application Publication
(10) Pub. No.: US 2026/0091577 A1
(43) Pub. Date: Apr. 2, 2026

(54) Liquid Ejecting Apparatus And Capacitive Load Drive Circuit

(71) Applicant: SEIKO EPSON CORPORATION, Tokyo (JP)

(72) Inventors: Dai NOZAWA, Matsumoto (JP); Noritaka IDE, Shiojiri (JP); Kunio TABATA, Shiojiri (JP); Rika TANIMOTO, Matsumoto (JP); Satoru UEMATSU, Shiojiri (JP)

(21) Appl. No.: 19/341,039

(22) Filed: Sep. 26, 2025

(30) Foreign Application Priority Data
Sep. 27, 2024 (JP) 2024-168917

(51) Int. Cl. B41J 2/045

(52) U.S. Cl. CPC B41J 2/04541; B41J 2/0455; B41J 2/04573; B41J 2/04581; B41J 2/04588; B41J 2/0459

(57) ABSTRACT

A liquid ejecting apparatus includes a capacitive load drive circuit that outputs a drive signal for displacing a capacitive load. The capacitive load drive circuit includes an amplification circuit that outputs an amplified modulated signal by driving of a first transistor and a second transistor, the first transistor being driven in response to a first gate drive signal corresponding to a modulated signal obtained by modulating a base signal output, the second transistor being driven in response to a second gate drive signal corresponding to the modulated signal; and a demodulation circuit that outputs the drive signal obtained by demodulating the amplified modulated signal. The first transistor and the second transistor includes a first layer including a first nitride semiconductor, and a second layer including a second nitride semiconductor having a band gap larger than that of the first nitride semiconductor. The second layer is disposed above the first layer.

The present application is based on, and claims priority from JP Application Serial Number 2024-168917, filed Sep. 27, 2024, the disclosure of which is hereby incorporated by reference herein in its entirety.

### BACKGROUND

### 1. Technical Field

The present disclosure relates to a liquid ejecting apparatus and a capacitive load drive circuit.

### 2. Related Art

In a liquid ejecting apparatus that ejects liquid by driving a capacitive load such as a piezoelectric element, a configuration using a so-called class-D amplification circuit is known as the configuration of a capacitive load drive circuit that outputs a drive signal for driving the capacitive load. The class-D amplification circuit modulates a signal waveform defined by a base drive signal which is the basis of the drive signal, amplifies the modulated signal, and demodulates the amplified signal, thereby generating the drive signal. The capacitive load drive circuit using such a class-D amplification circuit has the advantage that power consumption can be reduced compared with capacitive load drive circuits using a class-A amplification circuit, a class-B amplification circuit, and a class-AB amplification circuit.

For example, JP-A-2022-117051 discloses a liquid ejecting apparatus comprising a drive signal output circuit including a class-D amplification circuit, which is a capacitive load drive circuit that outputs a drive signal for driving a piezoelectric element as a capacitive load.

In response to increasing market demands for improved productivity in liquid ejecting apparatuses in recent years, the liquid ejecting apparatuses are required to shorten the ejection cycle of liquid, that is, to increase the frequency of a drive signal for driving a capacitive load to eject liquid.

However, in a liquid ejecting apparatus as described in JP-A-2022-117051, when increasing the frequency of a drive signal output by a capacitive load drive circuit (drive signal output circuit) including a class-D amplification circuit, it is necessary to increase the drive frequency of an amplification circuit that amplifies a modulated signal obtained by modulating a signal waveform defined by a base drive signal. When the drive frequency of the amplification circuit is increased, the loss in the amplification circuit increases, and this may impair one of the advantages of the capacitive load drive circuit using the class-D amplification circuit, that is, the ability to reduce power consumption.

In particular, when the liquid ejecting apparatus controls the ejection amount of liquid by driving a capacitive load with the drive signal and controlling the position of a meniscus in an ejection section by the driving of the capacitive load, the waveform accuracy of the drive signal significantly contributes to the ejection accuracy of liquid. Therefore, the capacitive load drive circuit is required to output a drive signal having a signal waveform with rapidly changing voltage values with high waveform accuracy. Therefore, to achieve a higher frequency of the drive signal while maintaining the high waveform accuracy, it is necessary to further increase the drive frequency of the amplification circuit of the capacitive load drive circuit. As a result, the loss in the amplification circuit further increases and the power consumption in the capacitive load drive circuit further increases.

That is, from the viewpoint of increasing the frequency of the drive signal output by the capacitive load drive circuit using the class-D amplification circuit, the technique described in JP-A-2022-117051 alone is not sufficient, and there is room for further improvement.

### SUMMARY

An aspect of the liquid ejecting apparatus according to the present disclosure includes a capacitive load that is displaced when supplied with a drive signal, an ejection section that ejects liquid in accordance with displacement of the capacitive load, and a capacitive load drive circuit that outputs the drive signal. The capacitive load drive circuit includes a modulation circuit that outputs a modulated signal obtained by modulating a base drive signal which is a basis of the drive signal; an amplification circuit that includes a first transistor and a second transistor and outputs an amplified modulated signal by driving of the first transistor and the second transistor, the first transistor being driven in response to a first gate drive signal corresponding to the modulated signal, the second transistor being driven in response to a second gate drive signal corresponding to the modulated signal; and a demodulation circuit that outputs the drive signal obtained by demodulating the amplified modulated signal. At least one of the first transistor and the second transistor includes a first layer including a first nitride semiconductor, and a second layer including a second nitride semiconductor having a band gap larger than a band gap of the first nitride semiconductor. The second layer is disposed above the first layer.

An aspect of the capacitive load drive circuit according to the present disclosure is a capacitive load drive circuit that outputs a drive signal to a capacitive load that is, when supplied with the drive signal, displaced to eject liquid from an ejection section. The capacitive load drive circuit includes a modulation circuit that outputs a modulated signal obtained by modulating a base drive signal which is a basis of the drive signal; an amplification circuit that includes a first transistor and a second transistor and outputs an amplified modulated signal by driving of the first transistor and the second transistor, the first transistor being driven in response to a first gate drive signal corresponding to the modulated signal, the second transistor being driven in response to a second gate drive signal corresponding to the modulated signal; and a demodulation circuit that outputs the drive signal obtained by demodulating the amplified modulated signal. At least one of the first transistor and the second transistor includes a first layer including a first nitride semiconductor, and a second layer including a second nitride semiconductor having a band gap larger than a band gap of the first nitride semiconductor. The second layer is disposed above the first layer.

### BRIEF DESCRIPTION OF THE DRAWINGS

FIG. 1 is a diagram illustrating an example of the schematic configuration of a liquid ejecting apparatus.

FIG. 2 is a diagram illustrating an example of the functional configuration of the liquid ejecting apparatus.

FIG. 3 is a diagram illustrating the schematic structure of one of ejection sections 600.

FIG. 4 is a diagram illustrating an example of signal waveforms of drive signals COMA, COMB, and COMC.

FIG. 5 is a diagram illustrating an example of the configurations of a selection control circuit and selection circuits.

FIG. 6 is a diagram illustrating an example of the details of decoding by decoders.

FIG. 7 is a diagram illustrating an example of the configuration of the selection circuits.

FIG. 8 is a diagram for explaining the operations of the selection control circuit and the selection circuits.

FIG. 9 is a diagram illustrating an example of the configuration of drive circuits.

FIG. 10 is a diagram illustrating an example of the structure of a transistor M1.

FIG. 11 is a diagram illustrating an example of the configuration of drive circuits of a second embodiment.

FIG. 12 is a diagram illustrating an example of the configuration of drive circuits of a third embodiment.

### DESCRIPTION OF EMBODIMENTS

Hereinafter, preferred embodiments of the present disclosure will be described with reference to the drawings. The drawings to be used are for convenience of description. The embodiments described below do not unduly limit the contents of the present disclosure described in the claims. In addition, all of configurations described below are not necessarily essential components of the present disclosure.

### 1. First Embodiment

### 1.1 Overview of Liquid Ejecting Apparatus

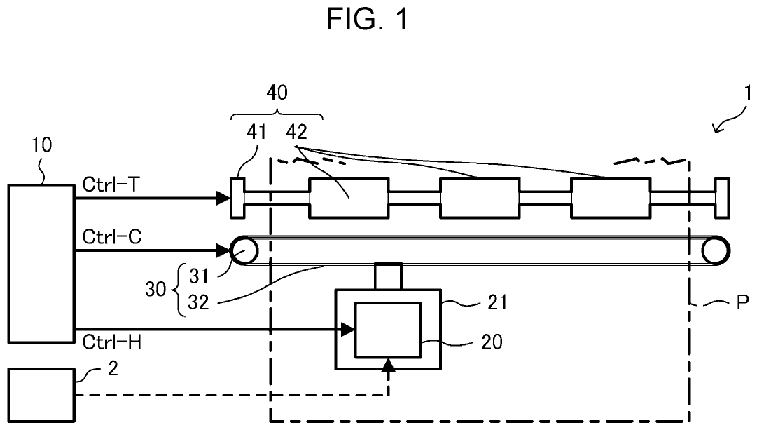

FIG. 1 is a diagram illustrating an example of the schematic configuration of a liquid ejecting apparatus 1.

The liquid ejecting apparatus 1 is a serial printing type ink jet printer in which a carriage 21, on which a head unit 20 that ejects ink as an example of liquid is mounted, reciprocates along a scanning axis and ejects ink onto a medium P transported in a transport direction, thereby forming a desired image on the medium P. As the medium P used in the liquid ejecting apparatus 1, a freely-selected printing target such as printing paper, a resin film, or fabric can be used. The liquid ejecting apparatus 1 is not limited to a serial printing type ink jet printer, and may be a line printing type ink jet printer. In addition, the liquid ejecting apparatus 1 is not limited to an ink jet printer, and may be a colorant ejecting apparatus that is used for manufacturing a color filter of a liquid crystal display or the like, an electrode material ejecting apparatus that is used for forming an electrode of an organic EL display, a surface emission display (FED), or the like, a bioorganic material ejecting apparatus that is used for manufacturing a biochip, a three-dimensional shaping apparatus, a textile printing apparatus, or the like.

As illustrated in FIG. 1, the liquid ejecting apparatus 1 includes an ink container 2, a control unit 10, the head unit 20, a moving unit 30, and a transport unit 40.

In the ink container 2, a plurality of types of ink to be ejected onto the medium P are stored. Examples of the color of the ink stored in the ink container 2 include black, cyan, magenta, yellow, red, and gray. As the ink container 2, in which the ink is stored, an ink cartridge, a bag-shaped ink pack formed of a flexible film, an ink tank which can be replenished with ink, or the like can be used.

The control unit 10 includes, for example, a processing circuit such as a central processing unit (CPU) or a field-programmable gate array (FPGA), a storage circuit such as a semiconductor memory, and various other circuits, and controls each element of the liquid ejecting apparatus 1 including the head unit 20.

The head unit 20 is mounted on the carriage 21. The carriage 21 is fixed to an endless belt 32 included in the moving unit 30. In addition to the head unit 20, the ink container 2 may be mounted on the carriage 21.

A control signal Ctrl-H for controlling the head unit 20, which is output by the control unit 10, is input to the head unit 20 mounted on the carriage 21. The ink stored in the ink container 2 is supplied to the head unit 20 through a tube (not illustrated). The head unit 20 ejects the ink supplied from the ink container 2, based on the input control signal Ctrl-H.

The moving unit 30 includes a carriage motor 31 and the endless belt 32. The carriage motor 31 is driven based on a control signal Ctrl-C input from the control unit 10. The endless belt 32 rotates in accordance with the driving of the carriage motor 31. Accordingly, the carriage 21 fixed to the endless belt 32 reciprocates along the scanning axis. That is, the liquid ejecting apparatus 1 includes the carriage 21, which reciprocates along the scanning axis intersecting the transport direction of the medium P, to be described later, on which the ink ejected from the head unit 20 lands.

The transport unit 40 includes a transport motor 41 and transport rollers 42. The transport motor 41 is driven based on a control signal Ctrl-T input from the control unit 10. The transport rollers 42 rotate in accordance with the driving of the transport motor 41. With the rotation of the transport rollers 42, the medium P is transported in the transport direction.

In the liquid ejecting apparatus 1 configured as described above, the head unit 20 mounted on the carriage 21 ejects ink onto the medium P in conjunction with the transport of the medium P by the transport unit 40 and the reciprocation of the carriage 21 by the moving unit 30. Accordingly, the ink ejected from the head unit 20 lands on a freely-selected position on the surface of the medium P.

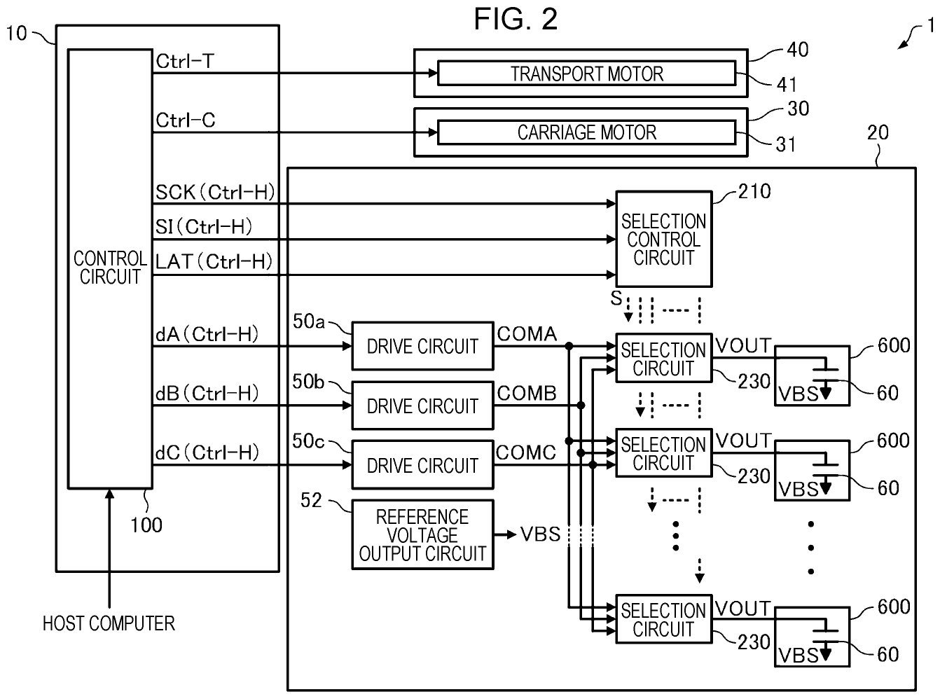

As a result, a desired image is formed on the medium P. A specific example of the functional configuration of the liquid ejecting apparatus 1 configured as described above will be described. FIG. 2 is a diagram illustrating an example of the functional configuration of the liquid ejecting apparatus 1. As illustrated in FIG. 2, the liquid ejecting apparatus 1 includes the control unit 10, the head unit 20, the moving unit 30, and the transport unit 40.

The control unit 10 includes a control circuit 100.

When an image signal is input from an external apparatus such as a host computer, the control circuit 100 generates various control signals corresponding to the image signal and outputs the control signals to the corresponding components.

Specifically, when the image signal is input and a printing process on the medium P is performed, the control circuit 100 generates the control signal Ctrl-T and the control signal Ctrl-C. The control signal Ctrl-T output by the control circuit 100 is input to the transport motor 41 included in the transport unit 40. The transport motor 41 is driven in response to the control signal Ctrl-T. The medium P is transported in the transport direction by the driving force of the transport motor 41. In addition, the control signal Ctrl-C output by the control circuit 100 is input to the carriage motor 31 included in the moving unit 30. The carriage motor 31 is driven in response to the control signal Ctrl-C. The carriage 21, on which the head unit 20 is mounted, reciprocates along the scanning axis by the driving force of the carriage motor 31. The transport unit 40 may include one or more transport rotors in addition to the transport motor 41. In addition, the transport unit 40 may include a transport motor driver circuit that converts the control signal Ctrl-T into a predetermined signal for driving the transport motor 41. Further, the moving unit 30 may include a carriage motor driver circuit that converts the control signal Ctrl-C into a predetermined signal for driving the carriage motor 31.

The control circuit 100 generates a clock signal SCK, a print data signal SI, a latch signal LAT, and digital base drive signals dA, dB, and dC as control signals Ctrl-H, based on the image signal input from the external apparatus, and outputs them to the head unit 20.

The head unit 20 includes drive circuits 50a, 50b, and 50c, a reference voltage output circuit 52, a selection control circuit 210, a plurality of selection circuits 230, and a plurality of ejection sections 600. The ejection sections 600 are provided so as to correspond to the selection circuits 230, respectively.

In other words, the head unit 20 including piezoelectric elements 60, the ejection sections 600, and the drive circuits 50a, 50b, and 50c is mounted on the carriage 21.

The base drive signal dA is input to the drive circuit 50a. The drive circuit 50a subjects the input base drive signal dA to digital-to-analog conversion and subjects the resultant analog signal to class-D amplification, thereby generating and outputting a drive signal COMA as a drive signal COM. The base drive signal dB is input to the drive circuit 50b. The drive circuit 50b subjects the input base drive signal dB to digital-to-analog conversion and subjects the resultant analog signal to class-D amplification, thereby generating and outputting a drive signal COMB as the drive signal COM. The base drive signal dC is input to the drive circuit 50c. The drive circuit 50c subjects the input base drive signal dC to digital-to-analog conversion and subjects the resultant analog signal to class-D amplification, thereby generating and outputting a drive signal COMC as the drive signal COM.

The reference voltage output circuit 52 steps up or down a power supply voltage (not illustrated), thereby generating and outputting a reference voltage signal VBS, which is a constant DC voltage having a voltage value of 5.5 V, 6 V, or the like. The reference voltage signal VBS functions as a reference potential for driving the piezoelectric elements 60 of the ejection sections 600, to be described later. The voltage value of the reference voltage signal VBS is not limited to 5.5 V and 6 V, and may be at ground potential.

The clock signal SCK, the print data signal SI, and the latch signal LAT are input to the selection control circuit 210. The selection control circuit 210 generates selection signals S corresponding to the selection circuits 230, based on the input clock signal SCK, the input print data signal SI, and the input latch signal LAT, and outputs the selection signals S to the corresponding selection circuits 230.

The drive signals COMA, COMB, and COMC and the corresponding selection signal S, which is output by the selection control circuit 210, are input to each of the selection circuits 230. The selection circuits 230 generate drive signals VOUT corresponding to the ejection sections 600 by selecting or not selecting each of the drive signals COMA, COMB, and COMC, based on the input selection signals S, and supply the drive signals VOUT to the corresponding ejection sections 600.

Each of the ejection sections 600 includes the piezoelectric element 60. The drive signal VOUT output by the corresponding selection circuit 230 is supplied to one end of the piezoelectric element 60 included in each of the ejection sections 600. In addition, the reference voltage signal VBS output by the reference voltage output circuit 52 is commonly supplied to the other end of the piezoelectric element 60 included in each of the ejection sections 600. Each of the piezoelectric elements 60 is driven in response to a potential difference between the drive signal VOUT supplied to the one end and the reference voltage signal VBS supplied to the other end. Ink in amounts corresponding to the driving of the piezoelectric elements 60 is ejected from the ejection sections 600.

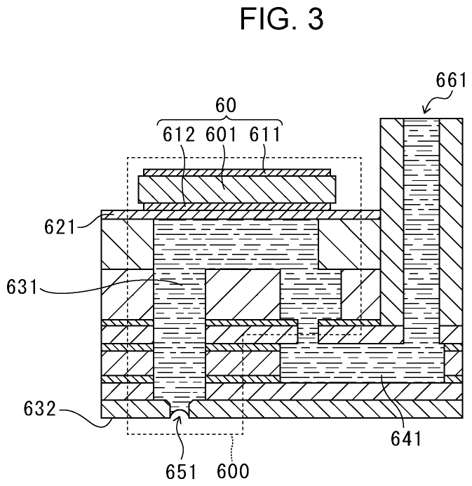

Here, an example of the structure of the ejection sections 600 of the head unit 20 will be described. FIG. 3 is a diagram illustrating the schematic structure of one of the ejection sections 600 of the head unit 20. As illustrated in FIG. 3, each of the ejection sections 600 includes the piezoelectric element 60, a vibration plate 621, a cavity 631, and a nozzle 651.

The cavity 631 is filled with ink supplied from a reservoir 641. The ink is introduced into the reservoir 641 from the ink container 2 through an ink tube (not illustrated) and a supply port 661. That is, the cavity 631 is filled with the ink stored in the corresponding ink container 2.

The vibration plate 621 is displaced by the driving of the piezoelectric element 60 provided on its upper surface in FIG. 3. With the displacement of the vibration plate 621, the internal volume of the cavity 631 filled with ink increases or decreases. That is, the vibration plate 621 functions as a diaphragm that changes the internal volume of the cavity 631.

The nozzle 651 is an opening provided in a nozzle plate 632 and communicating with the cavity 631. When the internal volume of the cavity 631 changes, ink in an amount corresponding to the change in the internal volume is ejected from the nozzle 651.

The piezoelectric element 60 has a structure in which a piezoelectric body 601 is interposed between a pair of electrodes 611 and 612. In the piezoelectric body 601 having such a structure, the central portions of the electrodes 611 and 612 bend upward or downward, together with the vibration plate 621, in accordance with the potential difference between the signals supplied to the electrodes 611 and 612.

For example, the drive signal VOUT is supplied to one of the electrodes 611 and 612, which is one end of the piezoelectric element 60, and the reference voltage signal VBS is supplied to the other of the electrodes 611 and 612, which is the other end of the piezoelectric element 60. The piezoelectric element 60 bends upward when the voltage value of the drive signal VOUT increases. In addition, when the piezoelectric element 60 bends upward, the vibration plate 621 is displaced, and the internal volume of the cavity 631 increases. As a result, ink is drawn from the reservoir 641. In contrast, when the voltage value of the drive signal VOUT decreases, the piezoelectric element 60 bends downward. When the piezoelectric element 60 bends downward, the vibration plate 621 is displaced, and the internal volume of the cavity 631 decreases. As a result, ink in an amount corresponding to the degree of decrease in the internal volume is ejected from the nozzle 651.

That is, each of the ejection sections 600 includes the piezoelectric element 60, which is driven by the drive signal VOUT based on the drive signal COM, and ejects ink by the driving of the piezoelectric element 60. In other words, the head unit 20 ejects ink in response to the drive signals COMA, COMB, and COMC.

In the liquid ejecting apparatus 1 of the present embodiment, it is here assumed that the head unit 20 includes 3,000 or more ejection sections 600, and the drive circuits 50a, 50b, and 50c supply the drive signals COMA, COMB, and COMC to the 3,000 or more ejection sections 600, from the viewpoint of improving the speed of image formation on the medium P, that is, improving the productivity in the liquid ejecting apparatus 1. That is, it is assumed that the head unit 20 includes 3,000 or more piezoelectric elements 60, and the drive circuits 50a, 50b, and 50c supply the drive signals COMA, COMB, and COMC to the 3,000 or more piezoelectric elements 60. This increases the amount of ink that can be ejected at a time, that is, the number of dots that can be formed on the medium P at a time, and can improve the speed of image formation on the medium P, that is, the productivity in the liquid ejecting apparatus 1. That is, the head unit 20 includes the 3,000 or more piezoelectric elements 60, and the 3,000 or more piezoelectric elements 60 are driven by the drive signals COMA, COMB, and COMC output by the drive circuits 50a, 50b, and 50c.

The structure of the piezoelectric elements 60 is not limited to the example illustrated in FIG. 3, and may be any structure as long as ink can be ejected from the ejection sections 600. Therefore, the structure of the piezoelectric elements 60 is not limited to the above-described structure using flexural vibration, and may be, for example, a structure using longitudinal vibration. Further, the piezoelectric elements 60 may be configured to bend downward when the voltage value of the drive signal VOUT increases, and to bend upward when the voltage value of the drive signal VOUT decreases.

As described above, the liquid ejecting apparatus 1 of the present embodiment includes the piezoelectric elements 60, which are displaced when supplied with the drive signals VOUT based on the drive signals COMA, COMB, and COMC; the ejection sections 600, which eject ink in accordance with the displacement of the piezoelectric elements 60; the drive circuit 50a, which outputs the drive signal COMA; the drive circuit 50b, which outputs the drive signal COMB; and the drive circuit 50c, which outputs the drive signal COMC.

### 1.2 Signal Waveforms of Drive Signals

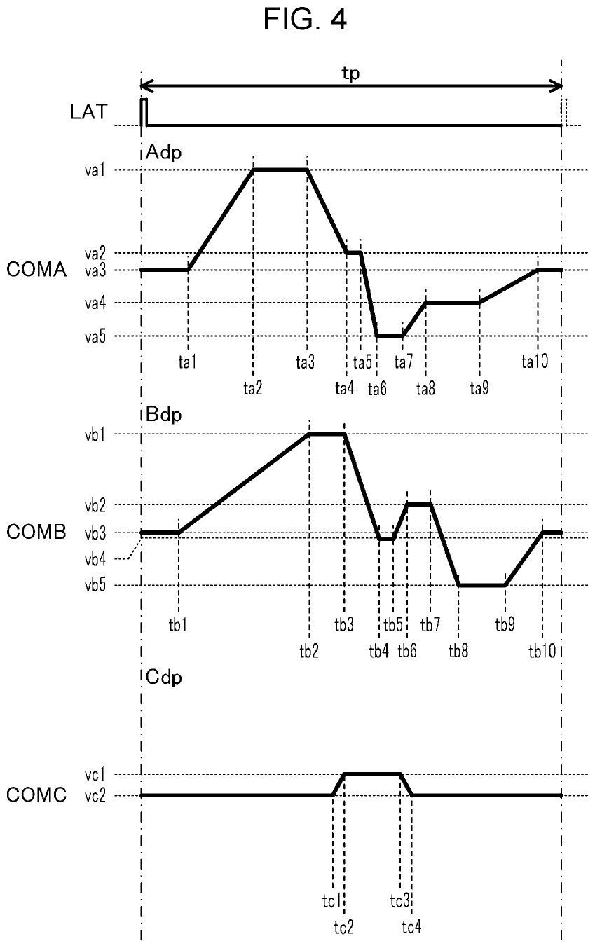

Next, an example of the respective signal waveforms of the drive signals COMA, COMB, and COMC output by the drive circuits 50a, 50b, and 50c will be described. FIG. 4 is a diagram illustrating an example of the signal waveforms of the drive signals COMA, COMB, and COMC. As illustrated in FIG. 4, the drive signals COMA, COMB, and COMC include drive waveforms Adp, Bdp, and Cdp, respectively, arranged in a cycle tp from the rising of the latch signal LAT to the next rising of the latch signal LAT. The selection control circuit 210 and the selection circuits 230 select any one of the drive signals COMA, COMB, and COMC, that is, any one of the drive waveforms Adp, Bdp, and Cdp, based on the clock signal SCK and the print data signal SI for each cycle tp, and output the selected signal as the drive signal VOUT.

As illustrated in FIG. 4, the voltage value of the drive waveform Adp changes between voltages va1 and va5 in the cycle tp, thereby driving the corresponding piezoelectric element 60. By the driving of the piezoelectric element 60, a predetermined amount of ink is ejected from the corresponding nozzle 651. That is, the drive waveform Adp included in the drive signal COMA is a signal waveform for driving the corresponding piezoelectric element 60 to eject a predetermined amount of ink from the ejection section 600. Here, in the following description, it is assumed that voltage va1 is 36 V, voltage va2 is 15 V, voltage va3 is 12 V, voltage va4 is 8 V, and voltage va5 is 5 V. However, the values of voltages va1 to va5 are not limited to these.

Specifically, at the timing when the latch signal LAT rises, that is, the timing when the cycle tp starts, the voltage value of the drive waveform Adp is constant at voltage va3. After that, the voltage value of the drive waveform Adp starts to increase at time ta1, and becomes constant at voltage va1 at time ta2. Then, the voltage value of the drive waveform Adp starts to decrease at time ta3, becomes constant at voltage va2 at time ta4, starts to decrease again at time ta5, and becomes constant at voltage va5 at time ta6. After that, the voltage value of the drive waveform Adp starts to increase at time ta7, becomes constant at voltage va4 at time ta8, starts to increase again at time ta9, and becomes constant at voltage va3 at time ta10. Then, the latch signal LAT rises and the cycle tp thereby ends.

In the ejection section 600 supplied with the drive waveform Adp as described above, the ink stored in the ink container 2 is supplied to the cavity 631 via the supply port 661 at the timing when the latch signal LAT rises. At this time, the position of the tip portion of the ink stored inside the nozzle 651 of the ejection section 600, that is, the position of the meniscus in the nozzle 651, is substantially the same as the position of the tip of the nozzle 651. Then, when the voltage value of the drive waveform Adp increases at time ta1, the piezoelectric element 60 bends in the upward direction illustrated in FIG. 3 and the internal volume of the cavity 631 increases in the ejection section 600 supplied with the drive waveform Adp. Accordingly, the ink stored inside the nozzle 651 of the ejection section 600 is drawn into the cavity 631, and the position of the meniscus in the nozzle 651 moves in the upward direction illustrated in FIG. 3.

After that, when the voltage value of the drive waveform Adp becomes constant at time ta2, the position of the meniscus in the nozzle 651 of the ejection section 600 is maintained. Then, when the voltage value of the drive waveform Adp decreases at time ta3, the piezoelectric element 60 bends in the downward direction illustrated in FIG. 3 and the internal volume of the cavity 631 decreases in the ejection section 600 supplied with the drive waveform Adp. Accordingly, the ink stored in the cavity 631 is pressurized and moves toward the corresponding nozzle 651. At this time, the central portion of the meniscus formed by the ink stored inside the nozzle 651 is pushed out, and a liquid column extending in the downward direction illustrated in FIG. 3 is formed.

When the voltage value of the drive waveform Adp becomes constant at time ta4, the liquid column formed in the central portion of the meniscus tends to extend in the downward direction illustrated in FIG. 3 due to inertial force. Then, at time ta5, the voltage value of the drive waveform Adp decreases, and the internal volume of the cavity 631 decreases, so that the ink stored in the cavity 631 is pressurized. As a result, ink is separated from the liquid column and is ejected as a droplet.

Then, at time ta6, the voltage value of the drive waveform Adp becomes constant, and from time ta7 to time ta10, the voltage value of the drive waveform Adp increases to become constant at voltage va3. Accordingly, the displacement of the piezoelectric element 60 of the ejection section 600 supplied with the drive waveform Adp and the internal volume of the cavity 631 are set to the state at the time of the rising of the latch signal LAT. At this time, ink in an amount corresponding to the amount of ejected ink is supplied from the ink container 2 to the cavity 631 via the supply port 661 by capillary action. Accordingly, the position of the meniscus in the nozzle 651 of the ejection section 600 at the rising timing of the latch signal LAT is substantially the same as the position of the tip of the nozzle 651.

As illustrated in FIG. 4, the voltage value of the drive waveform Bdp changes between voltages vb1 and vb5 in the cycle tp, thereby driving the corresponding piezoelectric element 60. By the driving of the piezoelectric element 60, a smaller amount of ink than the above-described predetermined amount is ejected from the corresponding nozzle 651. That is, the drive waveform Bdp included in the drive signal COMB is a signal waveform for driving the corresponding piezoelectric element 60 to eject a smaller amount of ink than the predetermined amount from the ejection section 600. Here, in the following description, it is assumed that voltage vb1 is 36 V, voltage vb2 is 20 V, voltage vb3 is 12 V, voltage vb4 is 10 V, and voltage vb5 is 7 V. However, the values of voltages vb1 to vb5 are not limited to these.

Specifically, at the timing when the latch signal LAT rises, that is, the timing when the cycle tp starts, the voltage value of the drive waveform Bdp is constant at voltage vb3. After that, the voltage value of the drive waveform Bdp starts to increase at time tb1 and becomes constant at voltage vb1 at time tb2. Then, the voltage value of the drive waveform Bdp starts to decrease at time tb3, becomes constant at voltage vb4 at a time tb4, starts to increase at time tb5, becomes constant at voltage vb2 at time tb6, then starts to decrease at time tb7, and becomes constant at voltage vb5 at time tb8. After that, the voltage value of the drive waveform Bdp starts to increase at time tb9 and becomes constant at voltage vb3 at time tb10. Then, the latch signal LAT rises and the cycle tp thereby ends.

In the ejection section 600 supplied with the drive waveform Bdp as described above, the ink stored in the ink container 2 is supplied to the cavity 631 via the supply port 661 at the timing when the latch signal LAT rises. At this time, the position of the tip portion of the ink stored inside the nozzle 651 of the ejection section 600, that is, the position of the meniscus in the nozzle 651, is substantially the same as the position of the tip of the nozzle 651. Then, when the voltage value of the drive waveform Bdp increases at time tb1, the piezoelectric element 60 bends in the upward direction illustrated in FIG. 3 and the internal volume of the cavity 631 increases in the ejection section 600 supplied with the drive waveform Bdp. Accordingly, the ink stored inside the nozzle 651 of the ejection section 600 is drawn into the cavity 631, and the position of the meniscus in the nozzle 651 moves in the upward direction illustrated in FIG. 3.

After that, when the voltage value of the drive waveform Bdp becomes constant at time tb2, the position of the meniscus in the nozzle 651 of the ejection section 600 is maintained. Then, when the voltage value of the drive waveform Bdp decreases at time tb3, the piezoelectric element 60 bends in the downward direction illustrated in FIG. 3 and the internal volume of the cavity 631 decreases in the ejection section 600 supplied with the drive waveform Bdp. Accordingly, the ink stored in the cavity 631 is pressurized and moves toward the corresponding nozzle 651. At this time, the central portion of the meniscus formed by the ink stored inside the nozzle 651 is pushed out, and a liquid column extending in the downward direction illustrated in FIG. 3 is formed.

When the voltage value of the drive waveform Bdp becomes constant at time tb4, the liquid column formed in the central portion of the meniscus tends to extend in the downward direction illustrated in FIG. 3 due to inertial force. Then, when the voltage value of the drive waveform Bdp increases and the internal volume of cavity 631 increases at time tb5, the liquid column that tends to extend in the downward direction illustrated in FIG. 3 due to inertial force is drawn inward. After that, at time tb6, the voltage value of the drive waveform Bdp becomes constant, and then, at time tb7, the voltage value of the drive waveform Bdp decreases. Thus, the internal volume of the cavity 631 decreases and the ink stored in the cavity 631 is pressurized, so that ink is separated from the liquid column and ejected as a droplet. In this case, after the liquid column that tends to extend in the downward direction illustrated in FIG. 3 due to inertial force is drawn inward at time tb5, the ink pressurized and separated from the liquid column is ejected as a droplet at time tb7. As a result, the amount of ink ejected from the ejection section 600 supplied with the drive waveform Bdp is smaller than the amount of ink ejected from the ejection section 600 supplied with the drive waveform Adp.

Then, at time tb8, the voltage value of the drive waveform Bdp becomes constant, and from time tb9 to time tb10, the voltage value of the drive waveform Bdp increases to become constant at voltage vb3. Accordingly, the displacement of the piezoelectric element 60 of the ejection section 600 supplied with the drive waveform Bdp and the internal volume of the cavity 631 are set to the state at the time of the rising of the latch signal LAT. At this time, ink in an amount corresponding to the amount of ejected ink is supplied from the ink container 2 to the cavity 631 via the supply port 661 by capillary action. Accordingly, the position of the meniscus in the nozzle 651 of the ejection section 600 at the rising timing of the latch signal LAT is substantially the same as the position of the tip of the nozzle 651.

As illustrated in FIG. 4, the voltage value of the drive waveform Cdp changes between voltages vc1 and vc2 in the cycle tp, thereby driving the corresponding piezoelectric element 60. By the driving of the piezoelectric element 60, ink is not ejected from the corresponding nozzle 651, and ink in the vicinity of the opening portion of the nozzle 651 vibrates. This reduces the possibility that the viscosity of the ink in the vicinity of the opening portion of the nozzle 651 increases. That is, the drive waveform Cdp included in the drive signal COMC is a signal waveform for driving the piezoelectric element 60 to vibrate the ink in the vicinity of the opening portion of the nozzle 651 of the ejection section 600 without ejecting the ink from the ejection section 600. Here, in the following description, it is assumed that voltage vc1 is 15 V and voltage vc2 is 12 V, but the values of voltage vc1 and voltage vc2 are not limited to these.

Specifically, at the timing when the latch signal LAT rises, that is, the timing when the cycle tp starts, the voltage value of the drive waveform Cdp is constant at voltage vc2. After that, the voltage value of the drive waveform Cdp starts to increase at time tc1 and becomes constant at voltage vc1 at time tc2. Then, the voltage value of the drive waveform Cdp starts to decrease at time tc3 and becomes constant at voltage vc2 at time tc4. Then, the latch signal LAT rises and the cycle tp thereby ends.

In the ejection section 600 supplied with the drive waveform Cdp as described above, the ink stored in the ink container 2 is supplied to the cavity 631 via the supply port 661 at the timing when the latch signal LAT rises. At this time, the position of the tip portion of the ink stored inside the nozzle 651 of the ejection section 600, that is, the position of the meniscus in the nozzle 651, is substantially the same as the position of the tip of the nozzle 651. Then, when the voltage value of the drive waveform Cdp increases at time tc1, the piezoelectric element 60 bends in the upward direction illustrated in FIG. 3 and the internal volume of the cavity 631 increases in the ejection section 600 supplied with the drive waveform Cdp. Accordingly, the ink stored inside the nozzle 651 of the ejection section 600 is drawn into the cavity 631, and the position of the meniscus in the nozzle 651 moves in the upward direction illustrated in FIG. 3. After that, when the voltage value of the drive waveform Cdp becomes constant at time tc2, the position of the meniscus in the nozzle 651 of the ejection section 600 is maintained. Then, when the voltage value of the drive waveform Cdp decreases at time tc3, the piezoelectric element 60 bends in the downward direction illustrated in FIG. 3 and the internal volume of the cavity 631 decreases in the ejection section 600 supplied with the drive waveform Cdp. Accordingly, the ink stored in the cavity 631 is pressurized and moves toward the corresponding nozzle 651. At this time, the central portion of the meniscus formed by the ink stored inside the nozzle 651 is pushed out, and a liquid column extending in the downward direction illustrated in FIG. 3 is formed. After that, at time tc4, the voltage value of the drive waveform Cdp becomes constant. At this time, the change in the voltage value of the drive waveform Cdp is smaller than the change in the voltage value of the drive waveform Adp and the change in the voltage value of the drive waveform Bdp, and thus, ink does not separate from the liquid column. Therefore, the ink only vibrates and is not ejected from the nozzle 651.

At time tc4, as the voltage value of the drive waveform Cdp becomes constant at voltage vc2, the displacement of the piezoelectric element 60 of the ejection section 600 supplied with the drive waveform Cdp and the internal volume of the cavity 631 are set to the state at the time of the rising of the latch signal LAT.

As described above, the drive circuit 50a outputs the drive signal COMA including the drive waveform Adp for driving the piezoelectric element 60 to eject a predetermined amount of ink from the ejection section 600, the drive circuit 50b outputs the drive signal COMB including the drive waveform Bdp for driving the piezoelectric element 60 to eject a smaller amount of ink than the predetermined amount from the ejection section 600, and the drive circuit 50c outputs the drive signal COMC including the drive waveform Cdp for driving the piezoelectric element 60 to vibrate ink in the vicinity of the opening portion of the corresponding nozzle 651 without ejecting ink from the ejection section 600. In the following description, the amount of ink ejected from the corresponding ejection section 600 when the drive waveform Adp is supplied to one end of the piezoelectric element 60 may be referred to as a “large amount”, and the amount of ink ejected from the corresponding ejection section 600 when the drive waveform Bdp is supplied to one end of the piezoelectric element 60 may be referred to as a “small amount”. In addition, the operation of vibrating ink in the vicinity of the nozzle opening portion of the ejection section 600 corresponding to the piezoelectric element 60 when the drive waveform Cdp is supplied to one end of the piezoelectric element 60 may be referred to as “micro-vibration”.

Here, in the liquid ejecting apparatus 1 of the present embodiment, it is assumed that the cycle tp, in which ink is ejected from the ejection sections 600 by the drive signals COMA, COMB, and COMC, is 10 μs or less, from the viewpoint of improving the speed of image formation on the medium P, that is, improving the productivity in the liquid ejecting apparatus 1. That is, it is assumed that the frequency of the drive signals COMA, COMB, and COMC output from the drive circuits 50a, 50b, and 50c, that is, the frequency of the cycle tp is 100 kHz or higher. Accordingly, in the liquid ejecting apparatus 1 of the present embodiment, it is possible to improve the speed of image formation on the medium P, that is, improve the productivity in the liquid ejecting apparatus 1.

### 1.3 Configurations and Operations of Selection Control Circuit and Selection Circuits

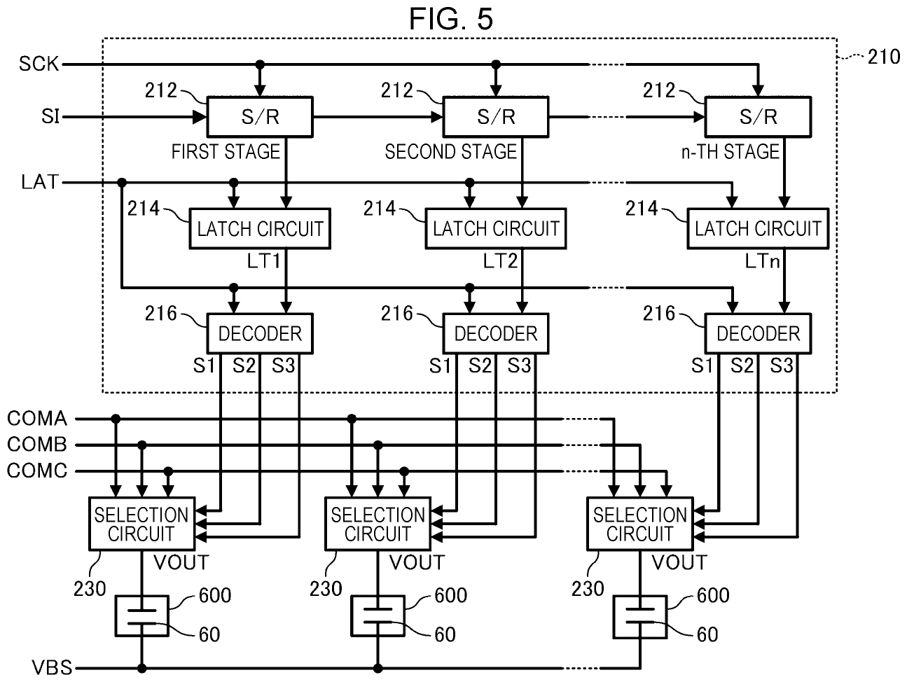

Next, the configurations and operations of the selection control circuit 210 and the selection circuits 230 that generate the drive signals VOUT by selecting or not selecting the signal waveforms included in the drive signals COMA, COMB, and COMC and output the drive signals VOUT to the corresponding ejection sections 600 will be described. FIG. 5 is a diagram illustrating an example of the configurations of the selection control circuit 210 and the selection circuits 230. In the following description, the 3,000 or more piezoelectric elements 60 of the head unit 20 will be described as n piezoelectric elements 60.

The clock signal SCK, the print data signal SI, and the latch signal LAT are input to the selection control circuit 210. In addition, in the selection control circuit 210, a combination of a shift register (S/R) 212, a latch circuit 214, and a decoder 216 is provided so as to correspond to each of the n piezoelectric elements 60. That is, the selection control circuit 210 includes n shift registers 212, n latch circuits 214, and n decoders 216.

The print data signal SI is input to the selection control circuit 210 in synchronization with the clock signal SCK. In addition, the print data signal SI serially includes 2-bit print data [SIH, SIL] for selecting any one of a “large dot LD”, a “small dot SD”, “non-recording ND”, and “micro-vibration BSD” such that the 2-bit print data [SIH, SIL] correspond to each of the n piezoelectric elements 60. The print data [SIH, SIL] included in the print data signal SI is held in the n shift registers 212 corresponding to the n piezoelectric elements 60. Specifically, the n shift registers 212 corresponding to the piezoelectric elements 60 are connected in cascade to each other, and the print data signal SI serially input is sequentially transferred to the shift register 212 of the subsequent stage in accordance with the clock signal SCK. Then, when the print data [SIH, SIL] is held in the corresponding shift registers 212, the input of the clock signal SCK is stopped. As a result, the print data [SIH, SIL] included in the print data signal SI is held in the corresponding shift registers 212. In FIG. 5, to distinguish the n shift registers 212, they are denoted as a first stage, a second stage, . . . , and an n-th stage in the order from the upstream side to which the print data signal SI is input.

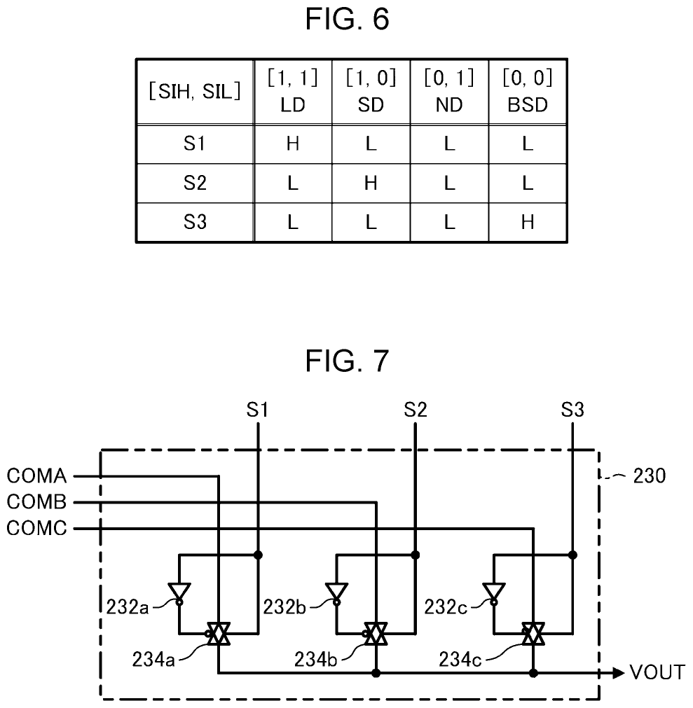

The n latch circuits 214 simultaneously latch the print data [SIH, SIL] held in the corresponding shift registers 212 at the rising of the latch signal LAT. Then, the print data [SIH, SIL] latched by the latch circuits 214 is input to the corresponding decoders 216. FIG. 6 is a diagram illustrating an example of the details of decoding by the decoders 216. The decoders 216 output selection signals S1, S2, and S3 as selection signals S with logic levels defined by the input print data [SIH, SIL] in the cycle tp. For example, when the print data [SIH, SIL]=[1, 0] is input to the decoders 216, the decoders 216 output an L-level selection signal S1, an H-level selection signal S2, and an L-level selection signal S3 in the cycle tp.

The selection signals S1, S2, and S3 output by the decoders 216 are input to the selection circuits 230. The selection circuits 230 are provided so as to correspond to the n ejection sections 600, respectively. FIG. 7 is a diagram illustrating an example of the configuration of the selection circuits 230. As illustrated in FIG. 7, each of the selection circuits 230 includes inverters 232a, 232b, and 232c, which are NOT circuits, and transfer gates 234a, 234b, and 234c.

The selection signal S1 is input to the positive control terminal, which is not marked with a circle in the transfer gate 234a, and is also input to the negative control terminal, which is marked with a circle in the transfer gate 234a, after the logic level is inverted by the inverter 232a. The drive signal COMA is supplied to the input terminal of the transfer gate 234a. The transfer gate 234a provides electrical continuity between the input terminal and the output terminal when the high-level selection signal S1 is input, and provides no electrical continuity between the input terminal and the output terminal when the low-level selection signal S1 is input. That is, the transfer gate 234a outputs the drive waveform Adp included in the drive signal COMA from the output terminal when the logic level of the selection signal S1 is a high level, and does not output the drive waveform Adp included in the drive signal COMA from the output terminal when the logic level of the selection signal S1 is a low level.

The selection signal S2 is input to the positive control terminal, which is not marked with a circle in the transfer gate 234b, and is also input to the negative control terminal, which is marked with a circle in the transfer gate 234b, after the logic level is inverted by the inverter 232b. The drive signal COMB is supplied to the input terminal of the transfer gate 234b. The transfer gate 234b provides electrical continuity between the input terminal and the output terminal when the high-level selection signal S2 is input, and provides no electrical continuity between the input terminal and the output terminal when the low-level selection signal S2 is input. That is, the transfer gate 234b outputs the drive waveform Bdp included in the drive signal COMB from the output terminal when the logic level of the selection signal S2 is a high level, and does not output the drive waveform Bdp included in the drive signal COMB from the output terminal when the logic level of the selection signal S2 is a low level.

The selection signal S3 is input to the positive control terminal, which is not marked with a circle in the transfer gate 234c, and is also input to the negative control terminal, which is marked with a circle in the transfer gate 234c, after the logic level is inverted by the inverter 232c. The drive signal COMC is supplied to the input terminal of the transfer gate 234c. The transfer gate 234c provides electrical continuity between the input terminal and the output terminal when the high-level selection signal S3 is input, and provides no electrical continuity between the input terminal and the output terminal when the low-level selection signal S3 is input. That is, the transfer gate 234c outputs the drive waveform Cdp included in the drive signal COMC from the output terminal when the logic level of the selection signal S3 is a high level, and does not output the drive waveform Cdp included in the drive signal COMC from the output terminal when the logic level of the selection signal S3 is a low level.

In each of the selection circuits 230, the output terminal of the transfer gate 234a, the output terminal of the transfer gate 234b, and the output terminal of the transfer gate 234c are connected in common to a connection point. A signal at the connection point to which the output terminal of the transfer gate 234a, the output terminal of the transfer gate 234b, and the output terminal of the transfer gate 234c are connected in common is output as the drive signal VOUT.

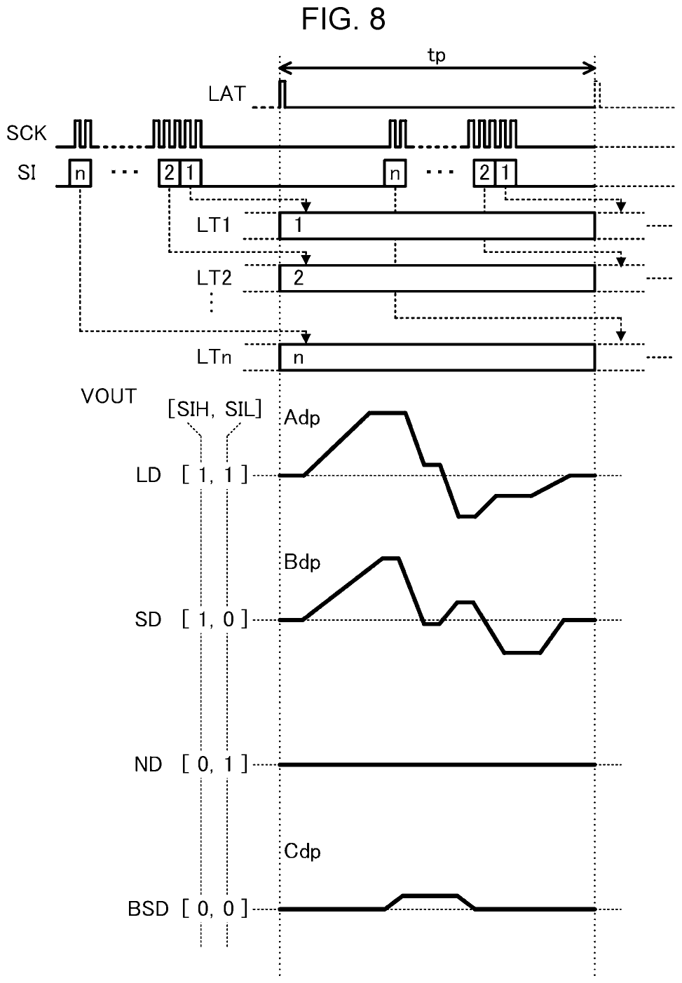

Here, the operations of the selection control circuit 210 and the selection circuits 230 will be described with reference to FIG. 8. FIG. 8 is a diagram for explaining the operations of the selection control circuit 210 and the selection circuits 230. The print data signal SI is input to the selection control circuit 210 as a serial signal synchronized with the clock signal SCK, and is sequentially transferred to the n shift registers 212 corresponding to the n piezoelectric elements 60 in synchronization with the clock signal SCK. Then, when the input of the clock signal SCK is stopped, the print data [SIH, SIL] corresponding to each of the n piezoelectric elements 60 is held in the corresponding shift register 212. The print data signal SI is input in the order corresponding to the piezoelectric elements 60 of the n-th stage, . . . , the second stage, and the first stage of the shift registers 212.

When the latch signal LAT rises, the latch circuits 214 simultaneously latch the print data [SIH, SIL] held in the shift registers 212. Note that LT1, LT2, . . . , and LTn illustrated in FIG. 8 indicate the print data [SIH, SIL] latched by the latch circuits 214 corresponding to the shift registers 212 of the first stage, the second stage, . . . , and the n-th stage.

The decoders 216 output the selection signals S1, S2, and S3 with logic levels defined by the latched print data [SIH, SIL] in each cycle tp. Then, the selection circuits 230 generate the drive signal VOUT by selecting or not selecting the drive signals COMA, COMB, and COMC in accordance with the logic levels of the selection signals S1, S2, and S3 output by the decoders 216.

Specifically, when the print data [SIH, SIL]=[1, 1] is input to one of the decoders 216, the decoder 216 sets the logic levels of the selection signals S1, S2, and S3 in the cycle tp to H, L, and L levels. Accordingly, the selection circuit 230 supplies the drive signal VOUT including the drive waveform Adp to the piezoelectric element 60 of the corresponding ejection section 600 in the cycle tp. As a result, a large amount of ink is ejected from the corresponding ejection section 600. The large amount of ink ejected from this ejection section 600 lands on the medium P, and a large dot LD is thereby formed on the medium P.

When the print data [SIH, SIL]=[1, 0] is input to the decoder 216, the decoder 216 sets the logic levels of the selection signals S1, S2, and S3 in the cycle tp to L, H, and L levels. Accordingly, the selection circuit 230 supplies the drive signal VOUT including the drive waveform Bdp to the piezoelectric element 60 of the corresponding ejection section 600 in the cycle tp. As a result, a small amount of ink is ejected from the corresponding ejection section 600. The small amount of ink ejected from this ejection section 600 lands on the medium P, and a small dot SD is thereby formed on the medium P.

When the print data [SIH, SIL]=[0, 1] is input to the decoder 216, the decoder 216 sets the logic levels of the selection signals S1, S2, and S3 in the cycle tp to L, L, and L levels. Accordingly, the selection circuit 230 does not select any of the drive waveforms Adp, Bdp, and Cdp in the cycle tp. At this time, the piezoelectric element 60 of the corresponding ejection section 600 is supplied with a signal of a constant voltage value held by the capacitance component of the piezoelectric element 60. That is, the selection circuit 230 supplies the drive signal VOUT of a constant voltage value to the piezoelectric element 60 of the corresponding ejection section 600 in the cycle tp. As a result, the piezoelectric element 60 of the corresponding ejection section 600 is not driven, and ink is not ejected from this ejection section 600. Therefore, ink does not land on the medium P, and the non-recording ND, in which no dot is formed on the medium P, is executed.

When the print data [SIH, SIL]=[0, 0] is input to the decoder 216, the decoder 216 sets the logic levels of the selection signals S1, S2, and S3 in the cycle tp to L, L, and H levels. Accordingly, the selection circuit 230 supplies the drive signal VOUT including the drive waveform Cdp to the piezoelectric element 60 of the corresponding ejection section 600 in the cycle tp. As a result, ink is not ejected from the corresponding ejection section 600, and the micro-vibration BSD for vibrating ink in the vicinity of the opening portion of the nozzle 651 of the ejection section 600 is executed.

As described above, the selection control circuit 210 and the selection circuits 230 generate the drive signals VOUT by selecting or not selecting the signal waveforms of the drive signals COMA, COMB, and COMC output by the drive circuits 50a, 50b, and 50c, and output the drive signals VOUT to the piezoelectric elements 60 of the corresponding ejection sections 600.

### 1.4 Configuration and Operation of Drive Circuits

Next, the configuration and operation of the drive circuits 50a, 50b, and 50c of the liquid ejecting apparatus 1 of the present embodiment will be described. Here, the drive circuits 50a, 50b, and 50c have the same configuration except that they input and output different signals.

Therefore, in the following description, the drive circuits 50a, 50b, and 50c will be simply referred to as a drive circuit 50 without distinguishing them. At that time, it will be explained that a base drive signal dO, as the base drive signals dA, dB, and dC, is input to the drive circuit 50, and the drive circuit 50 outputs the drive signal COM as the drive signals COMA, COMB, and COMC.

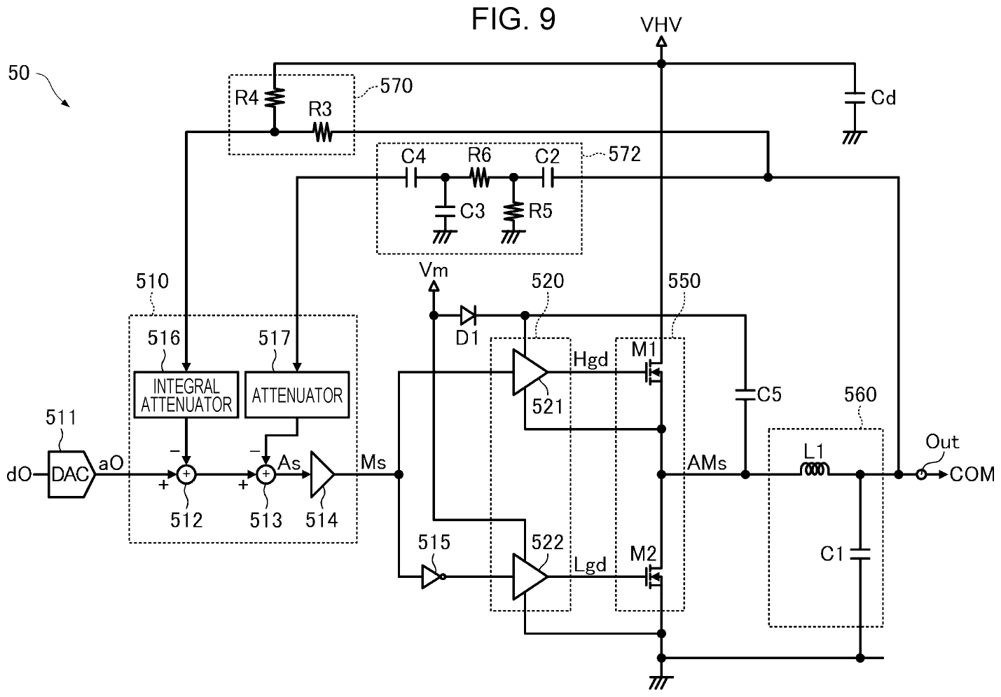

FIG. 9 is a diagram illustrating an example of the configuration of the drive circuit 50. As illustrated in FIG. 9, the drive circuit 50 includes a digital-to-analog converter (DAC) 511, a modulation circuit 510, a gate drive circuit 520, an amplification circuit 550, a demodulation circuit 560, feedback circuits 570 and 572, and other circuit elements.

The base drive signal dO, which is a digital signal that defines the signal waveform of the drive signal COM, is input to the DAC 511. The DAC 511 converts the input base drive signal dO into a base drive signal aO, which is an analog signal, and outputs it to the modulation circuit 510. A signal obtained by amplifying the base drive signal aO output from the DAC 511 corresponds to the drive signal COM. That is, the base drive signal aO is a target signal before the amplification of the drive signal COM, and the base drive signal dO is a target signal before the amplification of the drive signal COM and is a digital signal that defines the shape of the signal waveform of the drive signal COM. The voltage amplitude of the base drive signal aO output from the DAC 511 is set to, for example, 1 V to 2 V.

The modulation circuit 510 generates a modulated signal Ms by modulating the base drive signal aO, and outputs it to the gate drive circuit 520. The modulation circuit 510 includes adders 512 and 513, a comparator 514, an inverter 515, an integral attenuator 516, and an attenuator 517.

The integral attenuator 516 attenuates and integrates a signal corresponding to the voltage value of the drive signal COM input via the feedback circuit 570, to be described later, and outputs the integrated signal to the negative input terminal of the adder 512. The base drive signal aO is input to the positive input terminal of the adder 512. The adder 512 generates a signal having a voltage value obtained by subtracting the voltage value of the signal input to the negative input terminal from the voltage value of the signal input to the positive input terminal and integrating the result of the subtraction, and outputs the generated signal to the positive input terminal of the adder 513. Here, the maximum value of the voltage amplitude of the base drive signal aO is approximately 2 V as described above, whereas the voltage value of the drive signal COM may exceed 40 V at its maximum value. The integral attenuator 516 attenuates the drive signal COM input via the feedback circuit 570, to be described later, in order to conform the range of the voltage amplitude of the base drive signal aO to the range of the voltage value amplitude of the drive signal COM for calculation of a deviation.

The attenuator 517 supplies a voltage obtained by attenuating the high-frequency component of the drive signal COM input via the feedback circuit 572, to be described later, to the negative input terminal of the adder 513. The signal output by the adder 512 is input to the positive input terminal of the adder 513. The adder 513 generates a voltage signal As by subtracting the voltage value of the signal input to the negative input terminal from the voltage value of the signal input to the positive input terminal, and outputs the voltage signal As to the comparator 514. That is, the voltage signal As is a signal obtained by subtracting the voltage value of the signal input via the feedback circuit 570, to be described later, from the voltage value of the base drive signal aO, and further subtracting therefrom the voltage value of the signal input via the feedback circuit 572, to be described later. Therefore, the voltage signal As is a signal obtained by correcting the deviation obtained by subtracting the attenuated voltage of the drive signal COM from the voltage value of the base drive signal aO, which is the target signal, with the high-frequency component of the drive signal COM.

The comparator 514 subjects the voltage signal As to pulse modulation and outputs it as the modulated signal Ms. Specifically, the comparator 514 outputs the modulated signal Ms, which is set to an H level when the voltage value of the voltage signal As is greater than or equal to a predetermined threshold Vth1 during a period in which the voltage value of the voltage signal As is increasing, and is set to an L level when the voltage value of the voltage signal As is less than a predetermined threshold Vth2 during a period in which the voltage value of the voltage signal As is decreasing. The thresholds Vth1 and Vth2 are set such that the threshold Vth1 is greater than the threshold Vth2. The frequency and the duty ratio of the modulated signal Ms change in accordance with the base drive signals dO and aO. That is, the amounts of change in frequency and duty ratio of the modulated signal Ms can be adjusted by adjusting the modulation gain corresponding to the sensitivity of the attenuator 517.

The modulated signal Ms is input to a gate driver 521 included in the gate drive circuit 520. In addition, the modulated signal Ms is also input to a gate driver 522 included in the gate drive circuit 520 after the logic level is inverted by the inverter 515. That is, the signals whose logic levels are mutually exclusive are input to the gate driver 521 and the gate driver 522.

The timing of the signals input to the gate drivers 521 and 522 may be controlled such that the logic levels of the signals are not an H level at the same time. That is, the above-described state where the “logic levels are mutually exclusive” indicates the logic level of the signal input to the gate driver 521 and the logic level of the signal input to the gate driver 522 are not an H level at the same time, and includes a case where the logic level of the signal input to the gate driver 521 and the logic level of the signal input to the gate driver 522 are an L level at the same time.

The gate drive circuit 520 includes the gate driver 521 and the gate driver 522.

The gate driver 521 generates and outputs a gate signal Hgd by level-shifting the modulated signal Ms output by the comparator 514. The high-potential side of the power supply voltage of the gate driver 521 is electrically connected to one end of a capacitor C5 and the cathode of a diode D1. The other end of the capacitor C5 is electrically connected to a connection point between the source terminal of a transistor M1 and the drain terminal of a transistor M2. The anode of the diode D1 is supplied with a voltage signal Vm, which is a DC voltage of, for example, 7.5 V generated by a power supply circuit (not illustrated). As a result, a potential difference substantially equal to the voltage value of the voltage signal Vm is generated across the capacitor C5. The low-potential side of the power supply voltage of the gate driver 521 is electrically connected to the connection point between the source terminal of the transistor M1 and the drain terminal of the transistor M2. Therefore, the gate driver 521 generates and outputs the gate signal Hgd, in which the H-level voltage value is greater than the voltage value at the connection point between the source terminal of the transistor M1 and the drain terminal of the transistor M2 by the voltage value of the voltage signal Vm, and the L-level voltage value is the voltage value at the connection point between the source terminal of the transistor M1 and the drain terminal of the transistor M2, in accordance with the logic level of the input modulated signal Ms.

The gate driver 522 operates on a lower potential side than the gate driver 521. The gate driver 522 generates and outputs a gate signal Lgd by level-shifting a signal which is obtained by inverting, with the inverter 515, the logic level of the modulated signal Ms output by the comparator 514. Of the power supply voltage of the gate driver 522, the high-potential side is supplied with the voltage signal Vm, and the low-potential side is supplied with ground potential. In addition, the gate driver 522 generates and outputs the gate signal Lgd, in which the H-level voltage value is the voltage value of the voltage signal Vm and the L-level voltage value is ground potential, in accordance with the logic level of the input signal.

As described above, the gate signal Hgd is a signal obtained by level-shifting the voltage value of the modulated signal Ms, and the gate signal Lgd is a signal obtained by inverting the logic level of the modulated signal Ms and then level-shifting the voltage value of the inverted signal. Considering this point, the gate signal Hgd and the gate signal Lgd output from the gate drive circuit 520 can also be regarded as signals obtained by modulating the base drive signal dO and the base drive signal aO.

The amplification circuit 550 includes a transistor pair composed of the transistor M1 and the transistor M2.

A voltage signal VHV with, for example, a DC voltage of 42 V is supplied to the drain terminal of the transistor M1. Note that the voltage value of the voltage signal VHV is not limited to 42 V as long as it is greater than the maximum voltage value of the drive signal COM output by the drive circuit 50. The gate terminal of the transistor M1 is electrically connected to one end of a resistor R1. The gate signal Hgd is input to the other end of the resistor R1. That is, the gate signal Hgd is input to the gate terminal of the transistor M1 via the resistor R1. The source terminal of the transistor M1 is electrically connected to the drain terminal of the transistor M2. The conduction state between the drain terminal and the source terminal of the transistor M1 is controlled by the gate signal Hgd input to the gate terminal.

The drain terminal of the transistor M2 is electrically connected to the source terminal of the transistor M1. The gate terminal of the transistor M2 is electrically connected to one end of a resistor R2. The gate signal Lgd is input to the other end of the resistor R2. That is, the gate signal Lgd is input to the gate terminal of the transistor M2 via the resistor R2. Ground potential is supplied to the source terminal of the transistor M2. The conduction state between the drain terminal and the source terminal of the transistor M2 is controlled by the gate signal Lgd input to the gate terminal.

Here, in the following description, the state in which the transistors M1 and M2 are controlled such that electrical continuity exists between the drain terminals and the source terminals may be referred to as the transistors M1 and M2 being controlled to be on, and the state in which the transistors M1 and M2 are controlled such that no electrical continuity exists between the drain terminals and the source terminals may be referred to as the transistors M1 and M2 being controlled to be off.

In the amplification circuit 550 configured as described above, when the transistor M1 is controlled to be off and the transistor M2 is controlled to be on, the voltage value at the connection point between the source terminal of the transistor M1 and the drain terminal of the transistor M2 is ground potential. At this time, the voltage signal Vm is supplied to the high-potential side of the power supply voltage of the gate driver 521. In contrast, when the transistor M1 is controlled to be on and the transistor M2 is controlled to be off, the voltage value at the connection point between the source terminal of the transistor M1 and the drain terminal of the transistor M2 is that of the voltage signal VHV. At this time, the high-potential side of the power supply voltage of the gate driver 521 is supplied with a signal having a voltage value equal to the sum of the voltage value of the voltage signal VHV and the voltage value of the voltage signal Vm. That is, the gate driver 521, which drives the transistor M1, uses the capacitor C5 as a floating power supply. When the voltage value at the other end of the capacitor C5, that is, the connection point between the source terminal of the transistor M1 and the drain terminal of the transistor M2 changes to ground potential or the voltage value of the voltage signal VHV in accordance with the operations of the transistors M1 and M2, the gate driver 521 generates the gate signal Hgd, in which the L level is the voltage value of the voltage signal VHV and the H level is the sum of the voltage value of the voltage signal VHV and the voltage value of the voltage signal Vm, and supplies it to the gate terminal of the transistor M1.

On the other hand, the gate driver 522, which drives the transistor M2, generates the gate signal Lgd, in which the L level is ground potential and the H level is the voltage value of the voltage signal Vm, regardless of the operations of the transistors M1 and M2, and supplies it to the gate terminal of the transistor M2.

As described above, the amplification circuit 550 amplifies the modulated signal Ms obtained by modulating the base drive signals dO and aO, based on the voltage signal VHV, through the operations of the transistors M1 and M2 in accordance with the gate signals Hgd and Lgd. Then, the amplification circuit 550 outputs the amplified signal as an amplified modulated signal AMs from the connection point to which the source terminal of the transistor M1 and the drain terminal of the transistor M2 are connected in common.

The demodulation circuit 560 demodulates the amplified modulated signal AMs by smoothing it, and generates the drive signal COM. Then, the demodulation circuit 560 outputs the generated drive signal COM from the drive circuit 50.

The demodulation circuit 560 includes a coil L1 and a capacitor C1. One end of the coil L1 is electrically connected to the source terminal of the transistor M1 and the drain terminal of the transistor M2. As a result, the amplified modulated signal AMs is input to the one end of the coil L1. The other end of the coil L1 is connected to a terminal Out, which serves as the output terminal of the drive circuit 50. The other end of the coil L1 is also connected to one end of the capacitor C1. In addition, ground potential is supplied to the other end of the capacitor C1. That is, the coil L1 and the capacitor C1 constitute a low-pass filter. Further, the amplified modulated signal AMs is smoothed by the low-pass filter constituted by the demodulation circuit 560, and the drive signal COM is thereby generated.

The feedback circuit 570 includes a resistor R3 and a resistor R4. One end of the resistor R3 is connected to the terminal Out, from which the drive signal COM is output, and the other end of the resistor R3 is connected to the integral attenuator 516 of the modulation circuit 510 and one end of the resistor R4. The voltage signal VHV is supplied to the other end of the resistor R4. As a result, the drive signal COM, which has passed through the feedback circuit 570 from the terminal Out, in a pulled-up state is fed back to the integral attenuator 516 of the modulation circuit 510.

The feedback circuit 572 includes capacitors C2, C3, and C4 and resistors R5 and R6. One end of the capacitor C2 is coupled to the terminal Out, from which the drive signal COM is output, and the other end of the capacitor C2 is coupled to one end of the resistor R5 and one end of the resistor R6. Ground potential is supplied to the other end of the resistor R5. Thus, the capacitor C2 and the resistor R5 function as a high-pass filter.

The other end of the resistor R6 is connected to one end of the capacitor C4 and one end of the capacitor C3. Ground potential is supplied to the other end of the capacitor C3. Thus, the resistor R6 and the capacitor C3 function as a low-pass filter.

As described above, the feedback circuit 572 includes the high-pass filter and the low-pass filter. Thus, the feedback circuit 572 functions as a band-pass filter that passes a predetermined frequency band of the drive signal COM. In addition, the other end of the capacitor C4 of the feedback circuit 572 is connected to the attenuator 517 of the modulation circuit 510. Accordingly, a signal in which a DC component is cut among the high-frequency component of the drive signal COM, which has passed through the feedback circuit 572 functioning as a band-pass filter that passes a predetermined frequency component, is fed back to the attenuator 517 of the modulation circuit 510.

Incidentally, the drive signal COM output from the terminal Out is a signal obtained by smoothing and demodulating, with the demodulation circuit 560, the amplified modulated signal AMs based on the base drive signal dO. The drive signal COM output from the demodulation circuit 560 is integrated and attenuated via the feedback circuit 570, and then fed back to the adder 512. As a result, the drive circuit 50 self-oscillates at a frequency determined by a feedback delay and a feedback transfer function. However, the feedback path via the integral attenuator 516 of the modulation circuit 510 alone has a large delay amount, and with the feedback via the integral attenuator 516 of the modulation circuit 510 alone, there may be a case where the self-oscillation frequency cannot be increased to the extent that the accuracy of the drive signal COM can be sufficiently secured.

The drive circuit 50 of the present embodiment has a path for feeding back the high-frequency component of the drive signal COM via the feedback circuit 572 and the attenuator 517 of the modulation circuit 510, separately from the path via the integral attenuator 516 of the modulation circuit 510. As a result, in the drive circuit 50 of the present embodiment, the delay in the entire circuit constituting the drive circuit 50 is reduced, and the frequency of the voltage signal As can be increased to the extent that the accuracy of the drive signal COM can be sufficiently secured.

As described above, the drive circuit 50 of the present embodiment includes the modulation circuit 510, which outputs the modulated signal Ms obtained by modulating the base drive signals dO and aO, which are the bases of the drive signal COM; the gate drive circuit 520 including the gate driver 521, which outputs the gate signal Hgd corresponding to the modulated signal Ms, and the gate driver 522, which outputs the gate signal Lgd corresponding to the modulated signal Ms; the amplification circuit 550, which includes the transistor M1 and the transistor M2 and outputs the amplified modulated signal AMs by the driving of the transistors M1 and M2, the transistor M1 being driven in response to the gate signal Hgd, the transistor M2 being driven in response to the gate signal Lgd; the demodulation circuit 560, which outputs the drive signal COM obtained by demodulating the amplified modulated signal AMs; and the feedback circuits 570 and 572, which feed back the drive signal COM to the modulation circuit 510.

Here, when the oscillation frequency of the self-oscillation of the drive circuit 50, that is, the drive frequencies of the transistors M1 and M2 increase, the switching losses generated in the transistors M1 and M2 increase, and as a result, the amount of heat generated in the transistors M1 and M2 may increase. When the amount of heat generated in the transistors M1 and M2 increases, the stability of the operation of the drive circuit 50 including the transistors M1 and M2 deteriorates, and the waveform accuracy of the drive signal COM output by the drive circuit 50 deteriorates. In particular, the turn-on time and turn-off time of the transistors M1 and M2 and the drain current flowing through the transistors M1 and M2 greatly contribute to the switching losses generated in the transistors M1 and M2. Therefore, when the drive circuit 50 supplies the drive signal COM with a high frequency of 100 kHz or higher to the large number of piezoelectric elements 60, that is, the 3,000 or more piezoelectric elements 60 as in the liquid ejecting apparatus 1 of the present embodiment, there is a case where the amount of current flowing through the transistors M1 and M2 increases and the drive frequencies of the transistors M1 and M2 exceed 8 MHz. In this case, the switching losses in the transistors M1 and M2 significantly increase. This further increases the possibility that the amount of heat generated in the transistors M1 and M2 increases, and further increases the possibility that the stability of the operation of the drive circuit 50 deteriorates.

Regarding this problem, it is also possible to set the drive frequencies of the transistors M1 and M2 to those used when the frequency of the drive signal COM is 100 kHz or lower, thereby reducing the possibility of an increase in the switching losses in the transistors M1 and M2 and reducing the possibility of an increase in the amount of heat generated in the transistors M1 and M2. However, in the liquid ejecting apparatus 1 described in the present embodiment, which controls the position of the meniscus in the ejection sections 600 by the driving of the piezoelectric elements 60 and thereby controls the amount of ink ejected from the ejection sections 600, it is necessary to finely control the driving of the piezoelectric elements 60 in the cycle tp from the viewpoint of controlling the amount of ejected ink in detail. This requires a rapid, significant change in the voltage value of the drive signal COM as illustrated in FIG. 4. When the frequency of the drive signal COM is a high frequency of 100 kHz or higher, the voltage value of the drive signal COM may change sharply such that the amount of change per microsecond exceeds 20 V, and the period in which the voltage value of the drive signal COM is kept constant may be shorter than 0.25 μs. For this reason, in the drive circuit 50, which outputs the drive signal COM, when the drive frequencies of the transistors M1 and M2 are set to those when the frequency of the drive signal COM is 100 kHz or lower, there is a possibility that the number of samplings sufficient to maintain the waveform accuracy of the drive signal COM cannot be secured, so that the waveform accuracy of the output drive signal COM deteriorates and the ejection accuracy of ink deteriorates.

That is, from the viewpoint of improving productivity in the liquid ejecting apparatus 1, when the drive circuit 50 supplies the drive signal COM with a high frequency of 100 kHz or higher to the large number of piezoelectric elements 60, that is, the 3,000 or more piezoelectric elements 60, it is necessary to further increase the drive frequencies of the transistors M1 and M2 to maintain high waveform accuracy of the drive signal COM. Therefore, in the drive circuit 50, even when the drive frequencies of the transistors M1 and M2 are increased, it is required to reduce the possibility of deterioration in the waveform accuracy of the output drive signal COM while reducing the amount of heat generated in the drive circuit 50.

To satisfy this requirement, it may be possible to select transistors with low switching losses from among silicon-based transistors, which have been used as the transistors M1 and M2 in the related art. However, since the switching losses in transistors have a trade-off relationship with conduction losses, the conduction losses increase when transistors with low switching losses are selected. In this case, the amount of heat generated in the drive circuit 50 cannot be reduced. That is, in order for the drive circuit 50 of the liquid ejecting apparatus 1 to supply the drive signal COM with a high frequency of 100 kHz or higher to the large number of piezoelectric elements 60, that is, the 3,000 or more piezoelectric elements 60, transistors with both the conduction losses and switching losses reduced are required. Thus, transistors with a Baliga's figure of merit that exceeds that of silicon-based transistors are required.

Therefore, in the drive circuit 50 of the present embodiment, the transistors M1 and M2 have characteristic structures. This reduces the losses generated in the transistors M1 and M2 even when the transistors M1 and M2 are driven at high frequencies. Accordingly, even when the drive circuit 50 supplies the drive signals COMA, COMB, and COMC with a high frequency of 100 kHz or higher to the large number of piezoelectric elements 60, that is, the 3,000 or more piezoelectric elements 60, it is possible to reduce the possibility of deterioration in the waveform accuracy of the output drive signal COM while reducing the amount of heat generated in the drive circuit 50.

An example of the structure of the above-described transistors M1 and M2 will be described. Here, the transistor M1 and the transistor M2 have the same structure. Therefore, in the following description, only the structure of the transistor M1 will be described, and the illustration and description of the structure of the transistor M2 will be simplified or omitted.

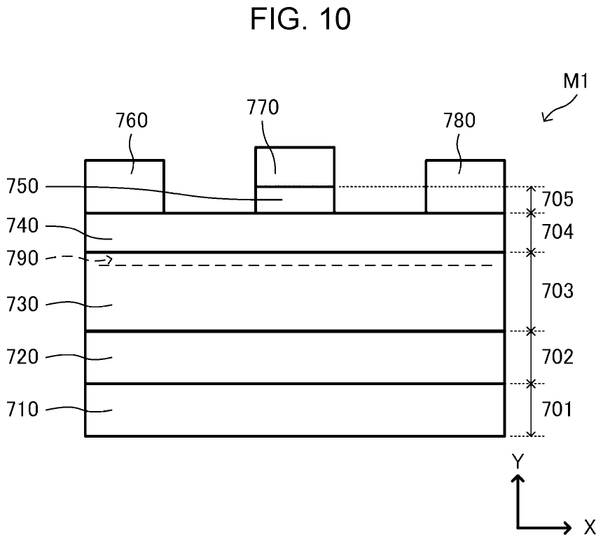

FIG. 10 is a diagram illustrating an example of the structure of the transistor M1. In describing the structure of the transistor M1, an X-axis and a Y-axis that are orthogonal to each other will be used for explanation. Also, in the following description, the starting point side of the arrow of the illustrated X-axis may be referred to as the −X side, and the tip end side may be referred to as the +X side. The starting point side of the arrow of the illustrated Y-axis may be referred to as the −Y side, and the tip end side may be referred to as the +Y side.

As illustrated in FIG. 10, the transistor M1 includes layers 701 to 705, a source electrode 760, a gate electrode 770, and a drain electrode 780.

The layer 701 is located at the most −Y side of the transistor M1 and includes a semiconductor substrate 710. As the semiconductor substrate 710, for example, a silicon (Si) substrate, a silicon carbide (SiC) substrate, a gallium nitride (GaN) substrate, or a sapphire substrate can be used.

The layer 702 is located above and on the +Y side of the layer 701, and includes a buffer layer 720. The buffer layer 720 is composed of one or more nitride semiconductors. The buffer layer 720 reduces the possibility of occurrence of warping of the semiconductor substrate 710 due to mismatch in thermal expansion coefficient between the semiconductor substrate 710 and an electron transit layer 730, to be described later, a crack in the transistor M1, and the like. The buffer layer 720 can be composed of, for example, aluminum nitride (AlN), aluminum gallium nitride (AlGaN), and graded AlGaN with a different aluminum (Al) composition, or the like.

The layer 703 is located above and on the +Y side of the layer 702, and includes the electron transit layer 730. The electron transit layer 730 is a nitride semiconductor, and is composed of, for example, GaN. Here, to reduce leakage current, impurities may be introduced into part of the electron transit layer 730 such that the region other than the surface layer region located on the +Y side is semi-insulating.

The layer 704 is located above and on the +Y side of the layer 703, and includes an electron supply layer 740. The electron supply layer 740 is a nitride semiconductor having a larger band gap than that of the electron transit layer 730, and is composed of, for example, AlGaN.

Here, the electron transit layer 730 and the electron supply layer 740 are composed of nitride semiconductors having lattice constants different from each other. Therefore, a lattice-mismatched heterojunction is formed between GaN, which is a nitride semiconductor constituting the electron transit layer 730, and AlGaN, which is a nitride semiconductor constituting the electron supply layer 740. At this time, the energy level of the conduction band of the electron transit layer 730 near the heterojunction interface becomes lower than the Fermi level due to the spontaneous polarization of the electron transit layer 730 and the electron supply layer 740 and the piezoelectric polarization caused by crystal strain near the heterojunction interface. As a result, a two-dimensional electron gas 790 spreads in the electron transit layer 730 in a region near the heterojunction interface between the electron transit layer 730 and the electron supply layer 740.

The layer 705 is located above and on the +Y side of the layer 704, and includes a gate layer 750. The gate layer 750 is composed of a nitride semiconductor containing an acceptor type impurity, for example, gallium nitride (p-type GaN) doped with an acceptor type impurity. As the acceptor type impurity used for doping, zinc (Zn), magnesium (Mg), carbon (C), or the like can be used, for example.

The gate electrode 770 is located above and on the +Y side of the gate layer 750 included in the layer 705, and is electrically connected to the gate terminal of the transistor M1. The gate electrode 770 is composed of one or more metal layers, for example, titanium nitride (TiN), and forms a Schottky junction with the gate layer 750. The gate electrode 770 may also be composed of, for example, a first metal layer made of titanium (Ti) and a second metal layer made of TiN provided above the first metal layer.

The source electrode 760 is located on the −X side of the gate layer 750 and the gate electrode 770, above and on the +Y side of the layer 704, and is electrically connected to the source terminal of the transistor M1. In addition, the drain electrode 780 is located on the +X side of the gate layer 750 and the gate electrode 770, above and on the +Y side of the layer 704, and is electrically connected to the drain terminal of the transistor M1. The source electrode 760 and the drain electrode 780 can be composed of one or more metal layers, for example, a freely-selected combination of Ti, TiN, Al, and the like. The source electrode 760 and the drain electrode 780 may also be composed of an alloy such as an aluminum-silicon-copper alloy (Al-Si-Cu) or an aluminum-copper alloy (AlCu).

That is, each of the transistors M1 and M2 includes the layer 703 including the electron transit layer 730 composed of a nitride semiconductor, for example, GaN; the layer 704 including a nitride semiconductor with a larger band gap than that of the electron transit layer 730, for example, AlGaN; the source electrode 760 electrically connected to the source terminal of each of the transistors M1 and M2; the drain electrode 780 electrically connected to the drain terminal of each of the transistors M1 and M2; and the gate electrode 770 electrically connected to the gate terminal of each of the transistors M1 and M2. The layer 704 is disposed above the layer 703, and the source electrode 760, the gate electrode 770, and the drain electrode 780 are disposed above the layer 704. At least part of the gate electrode 770 is located between the source electrode 760 and the drain electrode 780 when viewed along the Y-axis.

Next, the operations of the transistors M1 and M2 configured as described above will be described. When a 0 V signal is supplied to the gate electrode 770 and the potential of the gate electrode 770 is the same as that of the source electrode 760, the gate layer 750 raises the potential of the heterojunction interface between the electron transit layer 730 and the electron supply layer 740 serving as a channel. As a result, among the conduction bands at the heterojunction interface between the electron transit layer 730 and the electron supply layer 740, the conduction band located on the −Y side of the gate electrode 770 has a higher energy than the Fermi level. Therefore, the heterojunction interface between the electron transit layer 730 and the electron supply layer 740 serving as a channel is depleted. That is, when a 0 V signal is supplied to the gate electrode 770 and the gate electrode 770 and the source electrode 760 have the same potential, no electrical continuity exists between the source electrode 760 and the drain electrode 780 of each of the transistors M1 and M2, that is, between the drain terminal and the source terminal of each of the transistors M1 and M2.

On the other hand, when a signal having a positive voltage value is supplied to the gate electrode 770 and the voltage value of the signal exceeds a predetermined threshold voltage, the potential of the heterojunction interface between the electron transit layer 730 and the electron supply layer 740 serving as a channel decreases. At this time, electrons are generated at the heterojunction interface between the electron transit layer 730 and the electron supply layer 740 serving as a channel, and the transistors M1 and M2 operate in the same manner as an ordinary field-effect transistor (FET).

Then, when the voltage value of the signal supplied to the gate electrode 770 increases and exceeds the forward ON voltage of the pn junction, the injection of holes from the gate electrode 770 into the heterojunction interface between the electron transit layer 730 and the electron supply layer 740 serving as a channel starts. At this time, most of the electrons do not flow into the gate electrode 770 due to the potential barrier of the heterojunction. Therefore, at the heterojunction interface between the electron transit layer 730 and the electron supply layer 740 serving as a channel, the same amount of electrons as the holes injected from the gate electrode 770 are attracted from the source electrode 760 in order to satisfy the charge neutrality condition. The electrons attracted from the source electrode 760 move toward the drain electrode 780 at a high speed by the voltage supplied to the drain electrode 780. On the other hand, since the mobility of the holes is smaller than that of the electrons, most of the holes remain in the vicinity of the gate electrode 770. Therefore, in order to satisfy the charge neutrality condition, the same amount of electrons as the holes are further generated. Accordingly, the ratio between the number of injected holes and the number of generated electrons is substantially equal to the ratio between the mobility of the electrons and the mobility of the holes, and the drain current increases although the gate current hardly flows.

As described above, the transistors M1 and M2 are devices that include GaN and have the structure illustrated in FIG. 10, thereby utilizing conductivity modulation by hole injection from the gate electrode 770, and are GaN transistors with a low on-resistance high-electron-mobility transistor (HEMT) structure that exhibits normally-off characteristics while enabling large current drive. Here, the transistors M1 and M2 are not limited to the configuration illustrated in FIG. 10, as long as they are GaN transistors with the HEMT structure and can achieve normally-off characteristics. For example, the transistors M1 and M2 may include a cascode-connected MOS-FET instead of the gate layer 750 included in the layer 705.

Here, the GaN transistors are compound semiconductors using GaN as a semiconductor material, and all of the band gap, the dielectric breakdown electric field strength, the electron mobility, and the saturation electron velocity of GaN used as a semiconductor material are larger than those of Si, which is a mainstream semiconductor material. Therefore, the Baliga's figure of merit determined by comprehensive evaluation of multiple physical properties such as the dielectric breakdown electric field strength and the electron mobility of GaN used as a semiconductor material reaches “900”, when that of Si as a semiconductor material is defined as “1”. The GaN transistors using GaN as a semiconductor material can realize high-speed switching at a low on-resistance compared with Si transistors using Si as a semiconductor material. Furthermore, adopting the HEMT structure as the structure of the GaN transistors enables high-speed movement of electrons and reduces the possibility of high-speed switching being inhibited by parasitic capacitance, thus enabling even higher-speed switching.

By using the GaN transistors having the HEMT structure as the transistors M1 and M2 of the amplification circuit 550 included in the drive circuit 50 of the liquid ejecting apparatus 1 of the present embodiment, it is possible to reduce the losses generated in the transistors M1 and M2 even when the transistors M1 and M2 are driven at high frequencies. That is, even when the drive circuit 50 outputs a drive signal of 100 kHz or higher and the transistors M1 and M2 are driven at high frequencies of, for example, 8 MHz or higher, the amount of heat generated in the transistors M1 and M2 is reduced and the possibility of deterioration in the stability of the operation of the drive circuit 50 is reduced. Therefore, the possibility of deterioration in the waveform accuracy of the output drive signal COM is reduced, even when the drive circuit 50 supplies the drive signal COM having a high frequency of 100 kHz or higher to the large number of piezoelectric elements 60, that is, the 3,000 or more piezoelectric elements 60, from the viewpoint of improving the productivity in the liquid ejecting apparatus 1.

Furthermore, using the GaN transistors having the HEMT structure as the transistors M1 and M2 can reduce the losses generated in the transistors M1 and M2 even when the transistors M1 and M2 are driven at high frequencies. Thus, the power consumption of the drive circuit 50 can be reduced. In addition, since the transistors M1 and M2 can be driven at high frequencies, the frequency of the feedback signal fed back to the modulation circuit 510 via the feedback circuit 572 can be increased. As a result, the waveform accuracy of the drive signal COM output by the drive circuit 50 is further improved.

Since the transistors M1 and M2 can be driven at high frequencies, the frequency of the amplified modulated signal AMs output from the transistors M1 and M2 also increases. Accordingly, it is possible to reduce the size of the coil L1 of the demodulation circuit 560 and reduce the size of the drive circuit 50. In addition, by reducing the product of the coil L1 and the capacitor C1 of the demodulation circuit 560, the output bandwidth of the drive circuit 50 can also be widened, and the drive signal COM with high waveform accuracy can be output even when the voltage value of the drive signal COM changes steeply.

That is, in the drive circuit 50 of the present embodiment, since the transistors M1 and M2 have the characteristic structure illustrated in FIG. 10, the losses generated in the transistors M1 and M2 are reduced even when the transistors M1 and M2 are driven at high frequencies. Accordingly, even when the drive circuit 50 supplies the drive signals COMA, COMB, and COMC with a high frequency of 100 kHz or higher to the large number of piezoelectric elements 60, that is, the 3,000 or more piezoelectric elements 60, it is possible to reduce the possibility of deterioration in the waveform accuracy of the output drive signal COM while reducing the amount of heat generated in the drive circuit 50. Therefore, in the drive circuit 50 of the present embodiment, the losses generated in the transistors M1 and M2 can be reduced even in the following case: the drive frequency of the transistor M1 is set such that the shortest cycle in the drive cycle of the transistor M1 is shorter than the shortest period in the period during which the voltage value of the drive signal COM changes, and shorter than the shortest period in the period during which the voltage value of the drive signal COM is constant; the drive frequency of the transistor M2 is set such that the shortest cycle in the drive cycle of the transistor M2 is shorter than the shortest period in the period during which the voltage value of the drive signal COM changes, and shorter than the shortest period in the period during which the voltage value of the drive signal COM is constant; and the drive frequencies of the transistors M1 and M2 exceed 8 MHz in the period during which the transistors M1 and M2 output the amplified modulated signal AMs. As a result, it is possible to reduce the amount of heat generated in the drive circuit 50 and also reduce the possibility of deterioration in the waveform accuracy of the output drive signal COM.

Here, when the focus is only on the Baliga's figures of merit of the semiconductor materials constituting the transistors M1 and M2, SiC and gallium oxide (Ga2O3) as semiconductor materials also have large Baliga's figures of merit compared to Si. However, SiC and Ga2O3 are semiconductor materials assumed to be used at a high withstand voltage of several hundred V to several kV, and their switching performance at high frequencies is inferior to that of GaN. Therefore, SiC and Ga2O3 are not suitable semiconductor materials for application to the transistors M1 and M2 of the drive circuit 50 of the liquid ejecting apparatus 1, which is assumed to be used at a voltage value of 100 V or less and at high frequencies of several MHz.

Furthermore, when a vertical structure, not a HEMT structure, is adopted with GaN used as a semiconductor material, parasitic capacitance occurring between the gate and the source inhibits use at high frequencies of several MHz. Therefore, for the transistors M1 and M2 of the drive circuit 50 of the liquid ejecting apparatus 1, which is assumed to be used at a voltage value of 100 V or less and at high frequencies of several MHz, it can be said that the use of GaN transistors with a HEMT structure is optimal, when comprehensively considering not only the Baliga's figures of merit but also other physical properties and structures of semiconductor materials.

Here, the drive signal COM is an example of a drive signal, the piezoelectric elements 60 are examples of a capacitive load, the drive circuit 50 is an example of a capacitive load drive circuit, the gate signal Hgd is an example of a first gate drive signal, the transistor M1 is an example of a first transistor, the gate signal Lgd is an example of a second gate drive signal, the transistor M2 is an example of a second transistor, the layer 703 is an example of a first layer, gallium nitride (GaN), which is a nitride semiconductor of the electron transit layer 730, is an example of a first nitride semiconductor, the layer 704 is an example of a second layer, aluminum gallium nitride (AlGaN), which is a nitride semiconductor of the electron supply layer 740, is an example of a second nitride semiconductor, the source electrode 760 is an example of a first conductor, the drain electrode 780 is an example of a second conductor, the gate electrode 770 is an example of a third conductor, the cycle tp is an example of an ejection cycle, and the reciprocals of the drive frequencies of the transistors M1 and M2 are examples of a drive cycle.

### 1.5. Operational Effects

In the liquid ejecting apparatus 1 configured as described above, the drive circuit 50 includes the modulation circuit 510, which outputs the modulated signal Ms obtained by modulating the base drive signals dO and aO, which are the bases of the drive signal COM; the gate drive circuit 520 including the gate driver 521, which outputs the gate signal Hgd corresponding to the modulated signal Ms, and the gate driver 522, which outputs the gate signal Lgd corresponding to the modulated signal Ms; the amplification circuit 550, which includes the transistor M1 and the transistor M2 and outputs the amplified modulated signal AMs by the driving of the transistor M1 and the transistor M2, the transistor M1 being driven in response to the gate signal Hgd, the transistor M2 being driven in response to the gate signal Lgd; and the demodulation circuit 560, which outputs the drive signal COM obtained by demodulating the amplified modulated signal AMs. In this case, at least one and preferably both of the transistors M1 and M2 of the amplification circuit 550 include the layer 703 including the electron transit layer 730 composed of a nitride semiconductor, for example, GaN; the layer 704 composed of a nitride semiconductor having a larger band gap than that of the electron transit layer 730, for example, AlGaN; the source electrode 760 electrically connected to the source terminal of the at least one and preferably both of the transistors M1 and M2; the drain electrode 780 electrically connected to the drain terminal of the at least one and preferably both of the transistors M1 and M2; and the gate electrode 770 electrically connected to the gate terminal of the at least one and preferably both of the transistors M1 and M2. The layer 704 is disposed above the layer 703, and the source electrode 760, the gate electrode 770, and the drain electrode 780 are disposed above the layer 704. At least part of the gate electrode 770 is located between the source electrode 760 and the drain electrode 780 when viewed along the Y-axis. This configuration can reduce the losses generated in the transistors M1 and M2 even when the transistors M1 and M2 are driven at high frequencies. As a result, even when the frequency of the drive signal COM output by the drive circuit 50 using the class-D amplification circuit is high and, for example, the drive circuit 50 supplies the drive signals COMA, COMB, and COMC with a high frequency of 100 kHz or higher to the large number of piezoelectric elements 60, that is, the 3,000 or more piezoelectric elements 60, to meet market demands for improved productivity in the liquid ejecting apparatus 1, it is possible to reduce the amount of heat generated in the drive circuit 50 while reducing the possibility of deterioration in the waveform accuracy of the output drive signal COM.

In other words, by using a GaN transistor with a HEMT structure as at least one and preferably both of the transistors M1 and M2 of the amplification circuit 550, it is possible to reduce the losses generated in the transistors M1 and M2 even when the transistors M1 and M2 are driven at high frequencies. Therefore, even when the drive circuit 50 supplies the drive signals COMA, COMB, and COMC with a high frequency of 100 kHz or higher to the large number of piezoelectric elements 60, that is, the 3,000 or more piezoelectric elements 60, to meet market demands for improved productivity in the liquid ejecting apparatus 1, it is possible to reduce the amount of heat generated in the drive circuit 50 while reducing the possibility of deterioration in the waveform accuracy of the output drive signal COM.

Since the drive circuit 50 of the liquid ejecting apparatus 1 includes the feedback circuits 570 and 572, which feed back the drive signal COM to the modulation circuit 510, the transistors M1 and M2 are driven at high frequencies. This makes it possible to increase the response speed of the drive circuit 50 when viewed from the entire system of the drive circuit 50. Accordingly, it is possible to improve the waveform accuracy of the drive signal COM output by the drive circuit 50.

In the liquid ejecting apparatus 1 of the present embodiment, even when the transistors M1 and M2 are driven at high frequencies, it is possible to reduce the losses generated in the transistors M1 and M2. Thus, the heat generated in the drive circuit 50 including the transistors M1 and M2 is reduced. Therefore, even when the drive circuit 50 is mounted on the carriage 21 together with the ejection sections 600, the possibility that the physical properties of ejected ink will change due to the heat generation of the drive circuit 50 including the transistors M1 and M2 is reduced. In addition, by mounting the drive circuit 50 on the carriage 21 together with the ejection sections 600, it is possible to shorten the propagation path until the drive signal COM output by the drive circuit 50 is supplied to the ejection sections 600, thereby improving both the waveform accuracy of the drive signal COM supplied to the ejection sections 600 and the ejection accuracy of ink from the ejection sections 600.

### 2. Second Embodiment

Next, a liquid ejecting apparatus 1 of the second embodiment will be described. In the description of the liquid ejecting apparatus 1 of the second embodiment, the same components as those of the liquid ejecting apparatus 1 of the first embodiment are denoted by the same reference signs, and the detailed description thereof will be simplified or omitted.

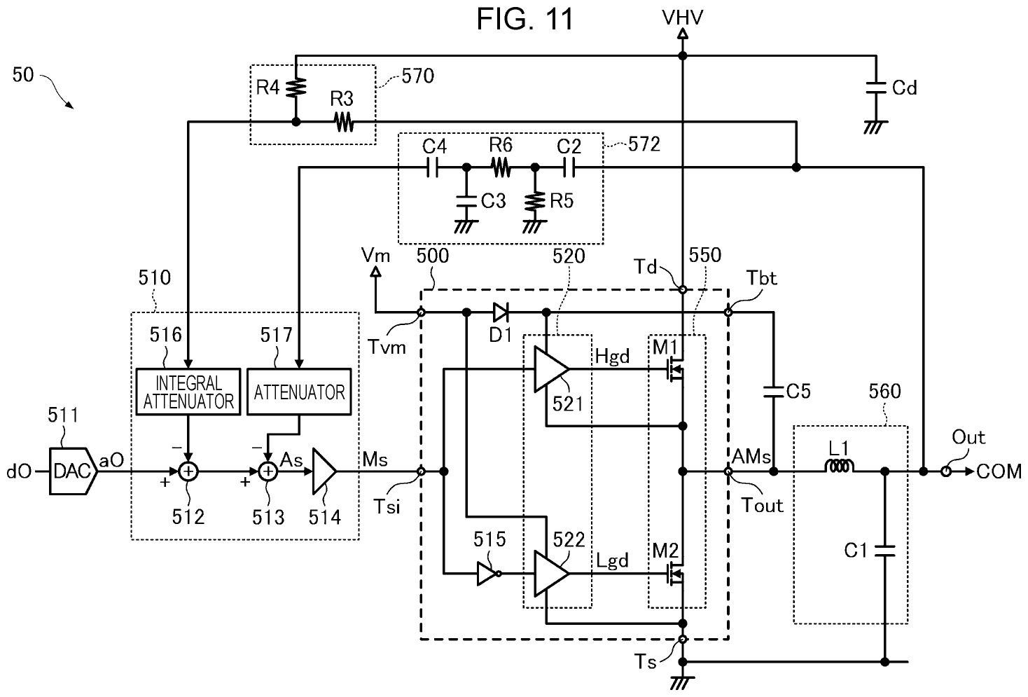

FIG. 11 is a diagram illustrating an example of the configuration of the drive circuit 50 of the second embodiment. The liquid ejecting apparatus 1 of the second embodiment differs from the liquid ejecting apparatus 1 of the first embodiment in that, in the drive circuit 50, the gate drive circuit 520, which outputs the gate signals Hgd and Lgd, and the transistors M1 and M2 are mounted on a single integrated circuit device 500.

As illustrated in FIG. 11, the integrated circuit device 500 includes terminals Tvm, Tsi, Td, Ts, Tout, and Tbt, the gate drive circuit 520, the amplification circuit 550, the diode D1, and the inverter 515.

The modulated signal Ms output from the modulation circuit 510 is input to the terminal Tsi. The voltage signal Vm is supplied to the terminal Tvm. The voltage signal VHV is supplied to the terminal Td. Ground potential is supplied to the terminal Ts. One end of the capacitor C5 is electrically connected to the terminal Tbt. The other end of the capacitor C5 is electrically connected to the terminal Tout. The terminal Tout is electrically connected to one end of the coil L1 of the demodulation circuit 560.

The modulated signal Ms is input to the gate driver 521 included in the gate drive circuit 520 via the terminal Tsi. In addition, after the modulated signal Ms is input to the inverter 515 via the terminal Tsi, the logic level of the modulated signal Ms is inverted by the inverter 515 and the modulated signal Ms is also input to the gate driver 522 included in the gate drive circuit 520. That is, the signals whose logic levels are mutually exclusive are input to the gate driver 521 and the gate driver 522.

The gate driver 521 generates and outputs the gate signal Hgd by level-shifting the modulated signal Ms. The high-potential side of the power supply voltage of the gate driver 521 is electrically connected to the cathode of the diode D1, and is also electrically connected to one end of the capacitor C5 via the terminal Tbt. The other end of the capacitor C5 is electrically connected to the terminal Tout, and the terminal Tout is electrically connected to the connection point between the source terminal of the transistor M1 and the drain terminal of the transistor M2. The voltage signal Vm is supplied to the anode of the diode D1 via the terminal Tvm. As a result, a potential difference substantially equal to the voltage value of the voltage signal Vm is generated across the capacitor C5. The low-potential side of the power supply voltage of the gate driver 521 is the connection point between the source terminal of the transistor M1 and the drain terminal of the transistor M2, and is electrically connected to the terminal Tout. Therefore, the gate driver 521 generates and outputs the gate signal Hgd, in which the H-level voltage value is greater than the voltage value of the terminal Tout by the voltage value of the voltage signal Vm and the L-level voltage value is the voltage value of the terminal Tout, in accordance with the logic level of the input modulated signal Ms.

The gate driver 522 operates on a lower potential side than the gate driver 521. The gate driver 522 generates and outputs the gate signal Lgd by level-shifting a signal obtained by inverting, with the inverter 515, the logic level of the modulated signal Ms input via the terminal Tsi. Of the power supply voltage of the gate driver 522, the high-potential side is supplied with the voltage signal Vm via the terminal Tvm, and the low-potential side is supplied with ground potential via the terminal Ts. In addition, the gate driver 522 generates and outputs the gate signal Lgd, in which the H-level voltage value is the voltage value of the voltage signal Vm and the L-level voltage value is ground potential, in accordance with the logic level of the input signal.

The amplification circuit 550 includes a transistor pair composed of the transistor M1 and the transistor M2.

The voltage signal VHV is supplied to the drain terminal of the transistor M1 via the terminal Td. The gate signal Hgd is input to the gate terminal of the transistor M1. The source terminal of the transistor M1 is electrically connected to the terminal Tout and the drain terminal of the transistor M2. The conduction state between the drain terminal and the source terminal of the transistor M1 is controlled by the gate signal Hgd input to the gate terminal.

The drain terminal of the transistor M2 is electrically connected to the terminal Tout and the source terminal of the transistor M1. The gate signal Lgd is input to the gate terminal of the transistor M2. Ground potential is supplied to the source terminal of the transistor M2 via the terminal Ts. The conduction state between the drain terminal and the source terminal of the transistor M2 is controlled by the gate signal Lgd input to the gate terminal.

In the amplification circuit 550 configured as described above, when the transistor M1 is controlled to be off and the transistor M2 is controlled to be on, the voltage value of the terminal Tout becomes ground potential. At this time, the voltage signal Vm is supplied to the high-potential side of the power supply voltage of the gate driver 521. On the other hand, when the transistor M1 is controlled to be on and the transistor M2 is controlled to be off, the voltage value of the terminal Tout becomes the voltage signal VHV. At this time, the high-potential side of the power supply voltage of the gate driver 521 is supplied with a signal having a voltage value equal to the sum of the voltage value of the voltage signal VHV and the voltage value of the voltage signal Vm. That is, the gate driver 521, which drives the transistor M1, uses the capacitor C5 as a floating power supply. When the voltage value at the other end of the capacitor C5, that is, the terminal Tout changes to ground potential or the voltage value of the voltage signal VHV, in accordance with the operations of the transistors M1 and M2, the gate driver 521 generates the gate signal Hgd, in which the L level is the voltage value of the voltage signal VHV and the H level is the sum of the voltage value of the voltage signal VHV and the voltage value of the voltage signal Vm, and supplies it to the gate terminal of the transistor M1.

On the other hand, the gate driver 522, which drives the transistor M2, generates the gate signal Lgd, in which the L level is ground potential and the H level is the voltage value of the voltage signal Vm, regardless of the operations of the transistors M1 and M2, and supplies it to the gate terminal of the transistor M2.

As described above, the amplification circuit 550 amplifies the modulated signal Ms obtained by modulating the base drive signals dO and aO, based on the voltage signal VHV, through the operations of the transistors M1 and M2 in accordance with the gate signals Hgd and Lgd. Then, the amplification circuit 550 outputs the amplified signal from the terminal Tout as the amplified modulated signal AMs.

The demodulation circuit 560 demodulates the amplified modulated signal AMs by smoothing it, and generates the drive signal COM. Then, the demodulation circuit 560 outputs the generated drive signal COM from the drive circuit 50.

Also in the drive circuit 50 of the second embodiment configured as described above, since the transistors M1 and M2 have the structure illustrated in FIG. 10, the same operational effects as those of the liquid ejecting apparatus 1 of the first embodiment are achieved.

In the liquid ejecting apparatus 1 of the second embodiment, the gate drive circuit 520, which outputs the gate signals Hgd and Lgd, and the transistors M1 and M2 constitute the integrated circuit device 500 accommodated in a single package. This makes it possible to shorten the propagation path through which each of the gate signals Hgd and Lgd propagates, improving the waveform accuracy of the gate signal Hgd input to the transistor M1 and the waveform accuracy of the gate signal Lgd input to the transistor M2.

As described with respect to FIG. 10, the transistors M1 and M2 are GaN transistors with a HEMT structure each including the layer 703 including the electron transit layer 730 composed of a nitride semiconductor, for example, GaN; the layer 704 composed of a nitride semiconductor having a larger band gap than that of the electron transit layer 730, for example, AlGaN; the source electrode 760 electrically connected to the source terminal of each of the transistors M1 and M2; the drain electrode 780 electrically connected to the drain terminal of each of the transistors M1 and M2; and the gate electrode 770 electrically connected to the gate terminal of each of the transistors M1 and M2. The layer 704 is disposed above the layer 703, and the source electrode 760, the gate electrode 770, and the drain electrode 780 are disposed above the layer 704. At least part of the gate electrode 770 is located between the source electrode 760 and the drain electrode 780 when viewed along the Y-axis. This configuration enables high-frequency driving with high-speed switching.

However, when the wiring through which the gate signals Hgd and Lgd propagate is long, the waveforms of the gate signals Hgd and Lgd may be distorted due to the influence of the impedance component of the wiring. Therefore, when the wiring through which the gate signals Hgd and Lgd propagate is long, the drive frequencies of the transistors M1 and M2 may be limited by the waveform distortion of the gate signals Hgd and Lgd. In particular, in GaN transistors having a HEMT structure, such as the transistors M1 and M2 of the drive circuit 50 described in the present embodiment, high-speed switching is possible, and therefore, such a problem is significant.

Regarding this problem, in the liquid ejecting apparatus 1 of the second embodiment, it is possible to shorten the wiring through which each of the gate signals Hgd and Lgd propagates, thus reducing the possibility that distortion occurs in the respective signal waveforms of the gate signal Hgd input to the transistor M1 and the gate signal Lgd input to the transistor M2. Therefore, it is possible to further increase the drive frequencies of the transistors M1 and M2, and to further improve the waveform accuracy of the drive signal COM output by the drive circuit 50.

Here, the gate drive circuit 520 is an example of a gate drive circuit, and the integrated circuit device 500 is an example of a semiconductor device.

### 3. Third Embodiment

Next, a liquid ejecting apparatus 1 of the third embodiment will be described. In the description of the liquid ejecting apparatus 1 of the third embodiment, the same components as those of the liquid ejecting apparatuses 1 of the first embodiment and the second embodiment are denoted by the same reference signs, and the detailed description thereof will be simplified or omitted.

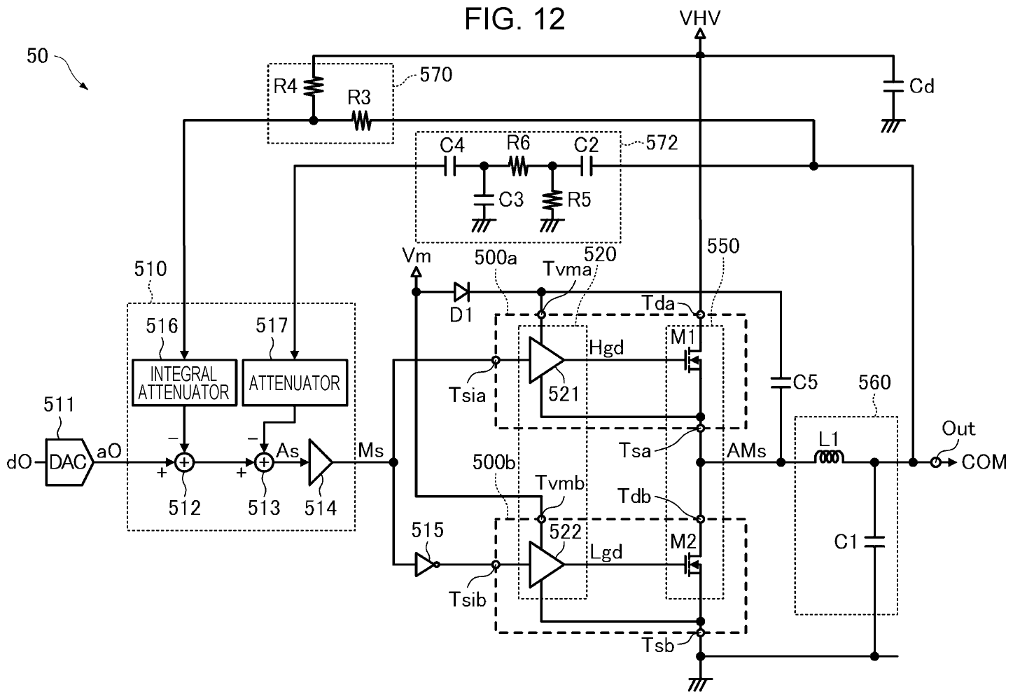

FIG. 12 is a diagram illustrating an example of the configuration of the drive circuit 50 of the third embodiment. The liquid ejecting apparatus 1 of the third embodiment is different from the liquid ejecting apparatuses 1 of the first embodiment and the second embodiment in that, in the drive circuit 50, the gate driver 521, which outputs the gate signal Hgd, and the transistor M1 are mounted on a single integrated circuit device 500a; and the gate driver 522, which outputs the gate signal Lgd, and the transistor M2 are mounted on a single integrated circuit device 500b.

As illustrated in FIG. 12, the integrated circuit device 500a includes terminals Tvma, Tsia, Tda, and Tsa, the gate driver 521, and the transistor M1, and the integrated circuit device 500b includes terminals Tvmb, Tsib, Tdb, and Tsb, the gate driver 522, and the transistor M2.

The modulated signal Ms output from the modulation circuit 510 is input to the terminal Tsia. The terminal Tvma is electrically connected to the cathode of the diode D1 and one end of the capacitor C5. The voltage signal VHV is supplied to the terminal Tda. The terminal Tsa is electrically connected to the terminal Tdb of the integrated circuit device 500b. In addition, the modulated signal Ms output from the modulation circuit 510 is input to the terminal Tsib via the inverter 515. The voltage signal Vm is input to the terminal Tvmb. The terminal Tdb is electrically connected to the terminal Tsa of the integrated circuit device 500a. Ground potential is supplied to the terminal Tsb.

The modulated signal Ms is input to the gate driver 521 via the terminal Tsia. In addition, the modulated signal Ms is also input to the gate driver 522 via the terminal Tsib after the logic level is inverted by the inverter 515. That is, the signals whose logic levels are mutually exclusive are input to the gate driver 521 and the gate driver 522.

The gate driver 521 generates and outputs the gate signal Hgd by level-shifting the modulated signal Ms. The high-potential side of the power supply voltage of the gate driver 521 is electrically connected to the cathode of the diode D1 and one end of the capacitor C5 via the terminal Tvma. The other end of the capacitor C5 is electrically connected to the terminal Tsa, and the terminal Tsa is electrically connected to the source terminal of the transistor M1. The voltage signal Vm is supplied to the anode of the diode D1. As a result, a potential difference substantially equal to the voltage value of the voltage signal Vm is generated across the capacitor C5. Of the power supply voltage of the gate driver 521, the low-potential side is the source terminal of the transistor M1 and is electrically connected to the terminal Tsa. Therefore, the gate driver 521 generates and outputs the gate signal Hgd, in which the H-level voltage value is greater than the voltage value of the terminal Tsa by the voltage value of the voltage signal Vm and the L-level voltage value is the voltage value of the terminal Tsa, in accordance with the logic level of the input modulated signal Ms.

The gate driver 522 generates and outputs the gate signal Lgd by level-shifting a signal obtained by inverting, with the inverter 515, the logic level of the modulated signal Ms input via the terminal Tsib. Of the power supply voltage of the gate driver 522, the high-potential side is supplied with the voltage signal Vm via the terminal Tvmb, and the low-potential side is supplied with ground potential via the terminal Tsb. In addition, the gate driver 522 generates and outputs the gate signal Lgd, in which the H-level voltage value is the voltage value of the voltage signal Vm and the L-level voltage value is ground potential, in accordance with the logic level of the input signal.

The voltage signal VHV is supplied to the drain terminal of the transistor M1 via the terminal Tda. The gate signal Hgd is input to the gate terminal of the transistor M1. The source terminal of the transistor M1 is electrically connected to the terminal Tsa. The conduction state between the drain terminal and the source terminal of the transistor M1 is controlled by the gate signal Hgd input to the gate terminal.

The drain terminal of the transistor M2 is electrically connected to the terminal Tdb. In addition, the terminal Tdb is electrically connected to the terminal Tsa. That is, the source terminal of the transistor M1 and the drain terminal of the transistor M2 are electrically connected via the terminal Tsa and the terminal Tdb. The gate signal Lgd is input to the gate terminal of the transistor M2. Ground potential is supplied to the source terminal of the transistor M2 via the terminal Tsb. The conduction state between the drain terminal and the source terminal of the transistor M2 is controlled by the gate signal Lgd input to the gate terminal.

When the transistor M1 is controlled to be off and the transistor M2 is controlled to be on, the voltage value at the connection point between the terminal Tsa and the terminal Tdb becomes ground potential. At this time, the voltage signal Vm is supplied to the high-potential side of the power supply voltage of the gate driver 521. On the other hand, when the transistor M1 is controlled to be on and the transistor M2 is controlled to be off, the voltage value at the connection point between the terminal Tsa and the terminal Tdb becomes the voltage signal VHV. At this time, the high-potential side of the power supply voltage of the gate driver 521 is supplied with a signal having a voltage value equal to the sum of the voltage value of the voltage signal VHV and the voltage value of the voltage signal Vm. That is, the gate driver 521, which drives the transistor M1, uses the capacitor C5 as a floating power supply. When the voltage value at the other end of the capacitor C5, that is, the connection point between the terminal Tsa and the terminal Tdb changes to ground potential or the voltage value of the voltage signal VHV, in accordance with the operations of the transistors M1 and M2, the gate driver 521 generates the gate signal Hgd, in which the L level is the voltage value of the voltage signal VHV and the H level is the sum of the voltage value of the voltage signal VHV and the voltage value of the voltage signal Vm, and supplies it to the gate terminal of the transistor M1.

On the other hand, the gate driver 522, which drives the transistor M2, generates the gate signal Lgd, in which the L level is ground potential and the H level is the voltage value of the voltage signal Vm, regardless of the operations of the transistors M1 and M2, and supplies it to the gate terminal of the transistor M2.

As described above, the transistors M1 and M2 operate in accordance with the gate signals Hgd and Lgd, and the modulated signal Ms, which is obtained by modulating the base drive signals dO and aO, is thereby amplified based on the voltage signal VHV. Then, the signal amplified by the transistors M1 and M2 is output from the connection point between the terminal Tsa and the terminal Tdb as the amplified modulated signal AMs.

The demodulation circuit 560 demodulates the amplified modulated signal AMs by smoothing it, and generates the drive signal COM. Then, the demodulation circuit 560 outputs the generated drive signal COM from the drive circuit 50.

Also in the drive circuit 50 of the third embodiment configured as described above, the transistors M1 and M2 have the structure as illustrated in FIG. 10, thereby achieving the same operational effects as those of the liquid ejecting apparatuses 1 of the first embodiment and the second embodiment.

At this time, in the liquid ejecting apparatus 1 according to the third embodiment, the gate driver 521, which outputs the gate signal Hgd, and the transistor M1 constitute the integrated circuit device 500a accommodated in a single package, and the gate driver 522, which outputs the gate signal Lgd, and the transistor M2 constitute the integrated circuit device 500b accommodated in a single package. This makes it possible to shorten the propagation path through which each of the gate signals Hgd and Lgd propagates, improving the waveform accuracy of the gate signal Hgd input to the transistor M1 and the waveform accuracy of the gate signal Lgd input to the transistor M2.

As described with respect to FIG. 10, the transistors M1 and M2 are GaN transistors with a HEMT structure each including the layer 703 including the electron transit layer 730 composed of a nitride semiconductor, for example, GaN; the layer 704 composed of a nitride semiconductor having a larger band gap than that of the electron transit layer 730, for example, AlGaN; the source electrode 760 electrically connected to the source terminal of each of the transistors M1 and M2; the drain electrode 780 electrically connected to the drain terminal of each of the transistors M1 and M2; and the gate electrode 770 electrically connected to the gate terminal of each of the transistors M1 and M2. The layer 704 is disposed above the layer 703, and the source electrode 760, the gate electrode 770, and the drain electrode 780 are disposed above the layer 704. At least part of the gate electrode 770 is located between the source electrode 760 and the drain electrode 780 when viewed along the Y-axis. This configuration enables high-frequency driving with high-speed switching.

However, when the wiring through which the gate signals Hgd and Lgd propagate is long, the waveforms of the gate signals Hgd and Lgd may be distorted due to the influence of the impedance component of the wiring. Therefore, when the wiring through which the gate signals Hgd and Lgd propagate is long, the drive frequencies of the transistors M1 and M2 may be limited by the waveform distortion of the gate signals Hgd and Lgd. In particular, in GaN transistors having a HEMT structure, such as the transistors M1 and M2 of the drive circuit 50 described in the present embodiment, high-speed switching is possible, and therefore, such a problem is significant.

Regarding this problem, in the liquid ejecting apparatus 1 of the third embodiment, as in the liquid ejecting apparatus 1 of the second embodiment, it is possible to shorten the wiring through which each of the gate signals Hgd and Lgd propagates, thus reducing the possibility that distortion occurs in the respective signal waveforms of the gate signal Hgd input to the transistor M1 and the gate signal Lgd input to the transistor M2. Therefore, it is possible to further increase the drive frequencies of the transistors M1 and M2, and to further improve the waveform accuracy of the drive signal COM output by the drive circuit 50.

Here, the gate driver 521 is an example of a first gate drive circuit, the gate driver 522 is an example of a second gate drive circuit, the integrated circuit device 500a is an example of a first semiconductor device, and the integrated circuit device 500b is an example of a second semiconductor device.

While the embodiments and modifications have been described above, the present disclosure is not limited to these embodiments, and can be implemented in various modes without departing from the scope of the present disclosure. For example, the above-described embodiments can also be combined as appropriate.

The present disclosure includes configurations that are substantially the same as those described in the embodiments (for example, a configuration with the same functions, methods, and results, or a configuration with the same purposes and effects as those described in the embodiments). Further, the present disclosure includes configurations in which a non-essential part of the configurations described in the embodiments is replaced. In addition, the present disclosure includes configurations that achieve the same operational effects as those of the configurations described in the embodiments or configurations that can achieve the same purposes as those of the configurations described in the embodiments. Further, the present disclosure includes configurations in which a known technology is added to the configurations described in the embodiments.

The following contents are derived from the above-described embodiments.

An aspect of a liquid ejecting apparatus includes a capacitive load that is displaced when supplied with a drive signal, an ejection section that ejects liquid in accordance with displacement of the capacitive load, and a capacitive load drive circuit that outputs the drive signal. The capacitive load drive circuit includes a modulation circuit that outputs a modulated signal obtained by modulating a base drive signal which is a basis of the drive signal; an amplification circuit that includes a first transistor and a second transistor and outputs an amplified modulated signal by driving of the first transistor and the second transistor, the first transistor being driven in response to a first gate drive signal corresponding to the modulated signal, the second transistor being driven in response to a second gate drive signal corresponding to the modulated signal; and a demodulation circuit that outputs the drive signal obtained by demodulating the amplified modulated signal. At least one of the first transistor and the second transistor includes a first layer including a first nitride semiconductor, and a second layer including a second nitride semiconductor having a band gap larger than a band gap of the first nitride semiconductor. The second layer is disposed above the first layer.

In this liquid ejecting apparatus, the at least one of the first transistor and the second transistor of the amplification circuit, which outputs the amplified modulated signal in response to the first gate drive signal and the second gate drive signal corresponding to the modulated signal, includes the first layer including the first nitride semiconductor and the second layer including the second nitride semiconductor having a larger band gap than that of the first nitride semiconductor, and the second layer is disposed above the first layer. Thus, even when the at least one of the first transistor and the second transistor is driven at high speed with an increase in the frequency of the output drive signal, the loss generated by the driving is reduced. Therefore, heat generated in the amplification circuit is reduced. As a result, the possibility of deterioration in the stability of the operation of the capacitive load drive circuit due to the heat generated in the amplification circuit is reduced, and the waveform accuracy of the drive signal output by the capacitive load drive circuit is improved.

In an aspect of the liquid ejecting apparatus, the at least one of the first transistor and the second transistor may include a first conductor electrically connected to a source terminal, a second conductor electrically connected to a drain terminal, and a third conductor electrically connected to a gate terminal. The first conductor, the second conductor, and the third conductor may be disposed above the second layer. At least part of the third conductor may be located between the first conductor and the second conductor.

In an aspect of the liquid ejecting apparatus, an ejection cycle in which the ejection section ejects liquid may be 10 μs or less.

In this liquid ejecting apparatus, the ejection cycle in which the ejection section ejects liquid is 10 μs or less. Thus, even when the drive signal output by the capacitive load drive circuit has a high frequency, the heat generated in the amplification circuit is reduced. This reduces the possibility of deterioration in the stability of the operation of the capacitive load drive circuit due to the heat generated in the amplification circuit, and reduces the possibility of deterioration in the waveform accuracy of the drive signal output by the capacitive load drive circuit.

In an aspect of the liquid ejecting apparatus, in a period in which the amplification circuit outputs the amplified modulated signal, the first transistor may be driven at a frequency of 8 MHz or higher and the second transistor may be driven at a frequency of 8 MHz or higher.

In this liquid ejecting apparatus, even when the drive frequencies of the first transistor and the second transistor are high frequencies of 8 MHz or higher, the loss due to the driving of at least one of the first transistor and the second transistor is reduced. Thus, the heat generated in the amplification circuit is reduced. Therefore, the possibility of deterioration in the stability of the operation of the capacitive load drive circuit due to the heat generated in the amplification circuit is reduced, and the possibility of deterioration in the waveform accuracy of the drive signal output by the capacitive load drive circuit is reduced.

In an aspect of the liquid ejecting apparatus, a shortest cycle of drive cycles of the first transistor may be shorter than a shortest period of periods in which a voltage value of the drive signal changes, and may be shorter than a shortest period of periods in which the voltage value of the drive signal is constant.

In this liquid ejecting apparatus, the shortest cycle of the drive cycles of the first transistor is shorter than the shortest period of the periods in which the voltage value of the drive signal changes, and is shorter than the shortest period of the periods in which the voltage value of the drive signal is constant. Thus, even when the drive frequencies of the first transistor and the second transistor are high frequencies, the loss due to the driving of at least one of the first transistor and the second transistor is reduced. Accordingly, the heat generated in the amplification circuit is reduced. Therefore, the possibility of deterioration in the stability of the operation of the capacitive load drive circuit due to the heat generated in the amplification circuit is reduced, and the waveform accuracy of the drive signal output by the capacitive load drive circuit is improved.

In an aspect of the liquid ejecting apparatus, the capacitive load drive circuit may include a feedback circuit that feeds back the drive signal to the modulation circuit.

In this liquid ejecting apparatus, even when the drive frequencies of the first transistor and the second transistor are high frequencies, the possibility of deterioration in the stability of the operation of the capacitive load drive circuit is reduced. Thus, in the capacitive load drive circuit, the responsiveness via the feedback circuit can be improved. Accordingly, the waveform accuracy of the drive signal output from the capacitive load drive circuit is improved.

An aspect of the liquid ejecting apparatus may include a carriage that moves along a main scanning axis intersecting a transport direction of a medium on which liquid ejected from the ejection section lands, the medium being transported in the transport direction. The capacitive load, the ejection section, and the capacitive load drive circuit may be mounted on the carriage.

In this liquid ejecting apparatus, the loss due to the driving of at least one of the first transistor and the second transistor is reduced, and the heat generated in the amplification circuit is reduced. Thus, even when the capacitive load drive circuit is mounted on the carriage, the possibility that the heat generated in the amplification circuit affects liquid and changes the properties of the liquid is reduced.

In an aspect of the liquid ejecting apparatus, the capacitive load drive circuit may include a gate drive circuit that outputs the first gate drive signal and the second gate drive signal, and the gate drive circuit, the first transistor, and the second transistor may constitute a semiconductor device accommodated in a single package.

In this liquid ejecting apparatus, since the gate drive circuit, the first transistor, and the second transistor are constituted by the semiconductor device accommodated in the single package, it is possible to shorten the wiring length through which the first gate drive signal and the second gate drive signal propagate. Therefore, the possibility of waveform distortion occurring in the first gate drive signal and the second gate drive signal input to the first transistor and the second transistor is reduced, and the drive accuracy of the first transistor and the second transistor is improved. In addition, the possibility of the drive frequencies of the first transistor and the second transistor being limited by the waveform distortion occurring in the first gate drive signal and the second gate drive signal is reduced, and the drive frequencies of the first transistor and the second transistor can be further increased.

In an aspect of the liquid ejecting apparatus, the capacitive load drive circuit may include a first gate drive circuit that outputs the first gate drive signal and a second gate drive circuit that outputs the second gate drive signal. The first gate drive circuit and the first transistor may be accommodated in a single package and constitute a first semiconductor device. The second gate drive circuit and the second transistor may be accommodated in a single package and constitute a second semiconductor device.

In this liquid ejecting apparatus, the first gate drive circuit and the first transistor are constituted by the first semiconductor device accommodated in the single package, and the second gate drive circuit and the second transistor are constituted by the second semiconductor device accommodated in the single package. Thus, it is possible to shorten the wiring length through which the first gate drive signal and the second gate drive signal propagate. Therefore, the possibility of waveform distortion occurring in the first gate drive signal and the second gate drive signal input to the first transistor and the second transistor is reduced, and the drive accuracy of the first transistor and the second transistor is improved. In addition, the possibility of the drive frequencies of the first transistor and the second transistor being limited by the waveform distortion occurring in the first gate drive signal and the second gate drive signal is reduced, and the drive frequencies of the first transistor and the second transistor can be further increased.

An aspect of a capacitive load drive circuit is a capacitive load drive circuit that outputs a drive signal to a capacitive load that is, when supplied with the drive signal, displaced to eject liquid from an ejection section. The capacitive load drive circuit includes a modulation circuit that outputs a modulated signal obtained by modulating a base drive signal which is a basis of the drive signal; an amplification circuit that includes a first transistor and a second transistor and outputs an amplified modulated signal by driving of the first transistor and the second transistor, the first transistor being driven in response to a first gate drive signal corresponding to the modulated signal, the second transistor being driven in response to a second gate drive signal corresponding to the modulated signal; and a demodulation circuit that outputs the drive signal obtained by demodulating the amplified modulated signal. At least one of the first transistor and the second transistor includes a first layer including a first nitride semiconductor, and a second layer including a second nitride semiconductor having a band gap larger than a band gap of the first nitride semiconductor. The second layer is disposed above the first layer.

In this capacitive load drive circuit, the at least one of the first transistor and the second transistor of the amplification circuit, which outputs the amplified modulated signal in response to the first gate drive signal and the second gate drive signal corresponding to the modulated signal, includes the first layer including the first nitride semiconductor and the second layer including the second nitride semiconductor having a larger band gap than that of the first nitride semiconductor, and the second layer is disposed above the first layer. Thus, even when the at least one of the first transistor and the second transistor is driven at high speed with an increase in the frequency of the output drive signal, the loss generated by the driving is reduced. Therefore, heat generated in the amplification circuit is reduced. As a result, the possibility of deterioration in the stability of the operation of the capacitive load drive circuit due to the heat generated in the amplification circuit is reduced, and the waveform accuracy of the drive signal output by the capacitive load drive circuit is improved.

In an aspect of the capacitive load drive circuit, the at least one of the first transistor and the second transistor may include a first conductor electrically connected to a source terminal, a second conductor electrically connected to a drain terminal, and a third conductor electrically connected to a gate terminal. The first conductor, the second conductor, and the third conductor may be disposed above the second layer. At least part of the third conductor may be located between the first conductor and the second conductor.

In an aspect of the capacitive load drive circuit, the ejection section may eject liquid in an ejection cycle of 10 μs or less.

In this capacitive load drive circuit, the ejection section ejects liquid in the ejection cycle of 10 μs or less. Thus, even when the drive signal output by the capacitive load drive circuit has a high frequency, the heat generated in the amplification circuit is reduced. This reduces the possibility of deterioration in the stability of the operation of the capacitive load drive circuit due to the heat generated in the amplification circuit, and reduces the possibility of deterioration in the waveform accuracy of the drive signal output by the capacitive load drive circuit.

In an aspect of the capacitive load drive circuit, in a period in which the amplification circuit outputs the amplified modulated signal, the first transistor may be driven at a frequency of 8 MHz or higher and the second transistor may be driven at a frequency of 8 MHz or higher.

In this capacitive load drive circuit, even when the drive frequencies of the first transistor and the second transistor are high frequencies of 8 MHz or higher, the loss due to the driving of at least one of the first transistor and the second transistor is reduced. Thus, the heat generated in the amplification circuit is reduced. Therefore, the possibility of deterioration in the stability of the operation of the capacitive load drive circuit due to the heat generated in the amplification circuit is reduced, and the possibility of deterioration in the waveform accuracy of the drive signal output by the capacitive load drive circuit is reduced.

In an aspect of the capacitive load drive circuit, a shortest cycle of drive cycles of the first transistor may be shorter than a shortest period of periods in which a voltage value of the drive signal changes, and may be shorter than a shortest period of periods in which the voltage value of the drive signal is constant.

In this capacitive load drive circuit, the shortest cycle of the drive cycles of the first transistor is shorter than the shortest period of the periods in which the voltage value of the drive signal changes, and is shorter than the shortest period of the periods in which the voltage value of the drive signal is constant. Thus, even when the drive frequencies of the first transistor and the second transistor are high frequencies, the loss due to the driving of at least one of the first transistor and the second transistor is reduced. Accordingly, the heat generated in the amplification circuit is reduced. Therefore, the possibility of deterioration in the stability of the operation of the capacitive load drive circuit due to the heat generated in the amplification circuit is reduced, and the waveform accuracy of the drive signal output by the capacitive load drive circuit is improved.

An aspect of the capacitive load drive circuit may include a feedback circuit that feeds back the drive signal to the modulation circuit.

In this capacitive load drive circuit, even when the drive frequencies of the first transistor and the second transistor are high frequencies, the possibility of deterioration in the stability of the operation of the capacitive load drive circuit is reduced. Thus, in the capacitive load drive circuit, the responsiveness via the feedback circuit can be improved. Accordingly, the waveform accuracy of the drive signal output from the capacitive load drive circuit is improved.

In an aspect of the capacitive load drive circuit, the capacitive load drive circuit may be mounted on a carriage that moves along a main scanning axis intersecting a transport direction of a medium on which liquid ejected from the ejection section lands, the medium being transported in the transport direction.

In this capacitive load drive circuit, the loss due to the driving of at least one of the first transistor and the second transistor is reduced, and the heat generated in the amplification circuit is reduced. Thus, even when the capacitive load drive circuit is mounted on the carriage, the possibility that the heat generated in the amplification circuit affects liquid and changes the properties of the liquid is reduced.

An aspect of the capacitive load drive circuit may include a gate drive circuit that outputs the first gate drive signal and the second gate drive signal. The gate drive circuit, the first transistor, and the second transistor may constitute a semiconductor device accommodated in a single package.

In this capacitive load drive circuit, since the gate drive circuit, the first transistor, and the second transistor are constituted by the semiconductor device accommodated in the single package, it is possible to shorten the wiring length through which the first gate drive signal and the second gate drive signal propagate. Therefore, the possibility of waveform distortion occurring in the first gate drive signal and the second gate drive signal input to the first transistor and the second transistor is reduced, and the drive accuracy of the first transistor and the second transistor is improved. In addition, the possibility of the drive frequencies of the first transistor and the second transistor being limited by the waveform distortion occurring in the first gate drive signal and the second gate drive signal is reduced, and the drive frequencies of the first transistor and the second transistor can be further increased.

An aspect of the capacitive load drive circuit may include a first gate drive circuit that outputs the first gate drive signal and a second gate drive circuit that outputs the second gate drive signal. The first gate drive circuit and the first transistor may be accommodated in a single package and constitute a first semiconductor device. The second gate drive circuit and the second transistor may be accommodated in a single package and constitute a second semiconductor device.

In this capacitive load drive circuit, the first gate drive circuit and the first transistor are constituted by the first semiconductor device accommodated in the single package, and the second gate drive circuit and the second transistor are constituted by the second semiconductor device accommodated in the single package. Thus, it is possible to shorten the wiring length through which the first gate drive signal and the second gate drive signal propagate. Therefore, the possibility of waveform distortion occurring in the first gate drive signal and the second gate drive signal input to the first transistor and the second transistor is reduced, and the drive accuracy of the first transistor and the second transistor is improved. In addition, the possibility of the drive frequencies of the first transistor and the second transistor being limited by the waveform distortion occurring in the first gate drive signal and the second gate drive signal is reduced, and the drive frequencies of the first transistor and the second transistor can be further increased.

What is claimed is:

1. A liquid ejecting apparatus comprising:
a capacitive load that is displaced when supplied with a drive signal;
an ejection section that ejects liquid in accordance with displacement of the capacitive load; and
a capacitive load drive circuit that outputs the drive signal,
the capacitive load drive circuit including:
a modulation circuit that outputs a modulated signal obtained by modulating a base drive signal which is a basis of the drive signal;
an amplification circuit that includes a first transistor and a second transistor and outputs an amplified modulated signal by driving of the first transistor and the second transistor, the first transistor being driven in response to a first gate drive signal corresponding to the modulated signal, the second transistor being driven in response to a second gate drive signal corresponding to the modulated signal; and
a demodulation circuit that outputs the drive signal obtained by demodulating the amplified modulated signal,
at least one of the first transistor and the second transistor including:
a first layer including a first nitride semiconductor; and
a second layer including a second nitride semiconductor having a band gap larger than a band gap of the first nitride semiconductor, wherein the second layer is disposed above the first layer.

2. The liquid ejecting apparatus according to claim 1, wherein
the at least one of the first transistor and the second transistor includes:
a first conductor electrically connected to a source terminal;
a second conductor electrically connected to a drain terminal; and
a third conductor electrically connected to a gate terminal,
the first conductor, the second conductor, and the third conductor are disposed above the second layer, and
at least part of the third conductor is located between the first conductor and the second conductor.

3. The liquid ejecting apparatus according to claim 1, wherein
an ejection cycle in which the ejection section ejects liquid is 10 μs or less.

4. The liquid ejecting apparatus according to claim 1, wherein
in a period in which the amplification circuit outputs the amplified modulated signal, the first transistor is driven at a frequency of 8 MHz or higher and the second transistor is driven at a frequency of 8 MHz or higher.

5. The liquid ejecting apparatus according to claim 1, wherein
a shortest cycle of drive cycles of the first transistor is shorter than a shortest period of periods in which a voltage value of the drive signal changes, and is shorter than a shortest period of periods in which the voltage value of the drive signal is constant.

6. The liquid ejecting apparatus according to claim 1, wherein
the capacitive load drive circuit includes a feedback circuit that feeds back the drive signal to the modulation circuit.

7. The liquid ejecting apparatus according to claim 1, further comprising:
a carriage that moves along a main scanning axis intersecting a transport direction of a medium on which liquid ejected from the ejection section lands, the medium being transported in the transport direction, wherein
the capacitive load, the ejection section, and the capacitive load drive circuit are mounted on the carriage.

8. The liquid ejecting apparatus according to claim 1, wherein
the capacitive load drive circuit includes a gate drive circuit that outputs the first gate drive signal and the second gate drive signal, and
the gate drive circuit, the first transistor, and the second transistor constitute a semiconductor device accommodated in a single package.

9. The liquid ejecting apparatus according to claim 1, wherein
the capacitive load drive circuit includes a first gate drive circuit that outputs the first gate drive signal and a second gate drive circuit that outputs the second gate drive signal,
the first gate drive circuit and the first transistor are accommodated in a single package and constitute a first semiconductor device, and
the second gate drive circuit and the second transistor are accommodated in a single package and constitute a second semiconductor device.

10. A capacitive load drive circuit that outputs a drive signal to a capacitive load that is, when supplied with the drive signal, displaced to eject liquid from an ejection section, the capacitive load drive circuit comprising:
a modulation circuit that outputs a modulated signal obtained by modulating a base drive signal which is a basis of the drive signal;
an amplification circuit that includes a first transistor and a second transistor and outputs an amplified modulated signal by driving of the first transistor and the second transistor, the first transistor being driven in response to a first gate drive signal corresponding to the modulated signal, the second transistor being driven in response to a second gate drive signal corresponding to the modulated signal; and
a demodulation circuit that outputs the drive signal obtained by demodulating the amplified modulated signal,
at least one of the first transistor and the second transistor including:
a first layer including a first nitride semiconductor; and
a second layer including a second nitride semiconductor having a band gap larger than a band gap of the first nitride semiconductor, wherein
the second layer is disposed above the first layer.

11. The capacitive load drive circuit according to claim 10, wherein
the at least one of the first transistor and the second transistor includes:
a first conductor electrically connected to a source terminal;
a second conductor electrically connected to a drain terminal; and
a third conductor electrically connected to a gate terminal,
the first conductor, the second conductor, and the third conductor are disposed above the second layer, and
at least part of the third conductor is located between the first conductor and the second conductor.

12. The capacitive load drive circuit according to claim 10, wherein
the ejection section ejects liquid in an ejection cycle of 10 μs or less.

13. The capacitive load drive circuit according to claim 10, wherein
in a period in which the amplification circuit outputs the amplified modulated signal, the first transistor is driven at a frequency of 8 MHz or higher and the second transistor is driven at a frequency of 8 MHz or higher.

14. The capacitive load drive circuit according to claim 10, wherein
a shortest cycle of drive cycles of the first transistor is shorter than a shortest period of periods in which a voltage value of the drive signal changes, and is shorter than a shortest period of periods in which the voltage value of the drive signal is constant.

15. The capacitive load drive circuit according to claim 10, further comprising:
a feedback circuit that feeds back the drive signal to the modulation circuit.

16. The capacitive load drive circuit according to claim 10, wherein
the capacitive load drive circuit is mounted on a carriage that moves along a main scanning axis intersecting a transport direction of a medium on which liquid ejected from the ejection section lands, the medium being transported in the transport direction.

17. The capacitive load drive circuit according to claim 10, further comprising:
a gate drive circuit that outputs the first gate drive signal and the second gate drive signal, wherein
the gate drive circuit, the first transistor, and the second transistor constitute a semiconductor device accommodated in a single package.

18. The capacitive load drive circuit according to claim 10, further comprising:
a first gate drive circuit that outputs the first gate drive signal and a second gate drive circuit that outputs the second gate drive signal, wherein
the first gate drive circuit and the first transistor are accommodated in a single package and constitute a first semiconductor device, and
the second gate drive circuit and the second transistor are accommodated in a single package and constitute a second semiconductor device.
